(19) United States
(12) Patent Application Publication
(10) Pub. No.: US 2017/0307095 A1
(43) Pub. Date: Oct. 26, 2017

(54) Rupture Disc Valve Device

(71) Applicant: Oklahoma Safety Equipment Company, Inc., Broken Arrow, OK (US)

(72) Inventors: Alan T. Wilson, Tulsa, OK (US); Hunter Franks, Tulsa, OK (US); Brandon Hentzen, Skiatook, OK (US); Michael Kmitta, Owasso, OK (US); Mark Randall Blackmon, Broken Arrow, OK (US); Robert Evans, Jenks, OK (US); Jerrod Phillip Johnson, Coweta, OK (US); Carl Ryan Ulrich, Broken Arrow, OK (US); Eric Alan Goodyear, Broken Arrow, OK (US); Doyle G. Stockstill, Sapulpa, OK (US)

(21) Appl. No.: 15/495,855

(22) Filed: Apr. 24, 2017

Related U.S. Application Data
(60) Provisional application No. 62/380,003, filed on Aug. 26, 2016.
(60) Provisional application No. 62/326,598, filed on Apr. 22, 2016.

(51) Int. Cl. F16K 17/16; F16K 27/02; A62C 35/68; F16K 39/02; F16K 27/10; A62C 35/02

(52) U.S. Cl. CPC F16K 17/16; F16K 39/02; F16K 27/102; F16K 27/02; A62C 35/68; A62C 35/023

(57) ABSTRACT

A rupture disc valve device as provided herein is configured to selectively release a pressurized material. In some embodiments, the rupture disc has a burst pressure rating less than a pressure of the pressurized material. The valve device selectively braces the rupture disc until release of the pressurized material is desired. To release the pressurized material, the valve device is configured to remove or adjust the bracing support to the rupture disc, allowing the pressurized material to burst the rupture disc.

### CROSS-REFERENCE TO RELATED APPLICATIONS

This application claims the benefit of U.S. Application No. 62/380,003, filed Aug. 26, 2016, and U.S. Application No. 62/326,598, filed Apr. 22, 2016, which are both incorporated by reference herein in their entireties.

### FIELD OF THE INVENTION

The present invention relates to a rupture disc valve device and its assembly and, more particularly, to a sealed rupture disc valve device, a welding method therefor, and rupture disc valve assemblies for a fire suppressant system.

### BACKGROUND OF THE INVENTION

Rupture discs are used in a variety of chemical process and manufacturing applications. In these applications, hazardous, caustic and corrosive media may be used or produced. For these systems, rupture disc valve assemblies that include a multi-piece holder are known where the rupture disc is held in place under the tension of a bolted flange. However, when exposed to harsh media, corrosion and disruption of the disc can cause unwanted leakage between the disc and the holder. In another approach, rupture disc assemblies have used a two-piece holder where the rupture disc is sandwiched between the two holder pieces and welded into place around the outer peripheries of the holder pieces and the rupture disc so that it is welded therebetween.

Fire suppressant systems are used in a variety of residential and commercial buildings. For areas that have important assets, such as computing devices, equipment, art, and the like, clean agent systems can be utilized rather than relying on water, which can cause extensive damage. A clean agent is an electrically nonconductive, volatile, or gaseous fire extinguishant that does not leave a residue upon evaporation. Clean agent systems commonly utilize a pressurized tank having a suppressant in a liquefied state and a propellant gas stored therein. After a fire event has triggered the system, a valve is opened and the propellant gas pushes the liquid suppressant through pipes of the system to an outlet.

In one prior art approach, an outlet of the tank is sealed by a piston-style valve assembly that includes a dumbbell-shaped valve member that is shiftable between closed and open positions relative to the tank outlet. Prior to use in a fire event, the valve body is pressurized with enough force to seat the valve member against the tank outlet and prevent the flow of liquid suppressant and gas therefrom. In addition to the back pressure, the valve member can also be biased against the tank outlet with a spring. Thereafter, when a fire event is triggered, the back pressure is vented, which allows the pressure from the propellant gas to push the valve member away from the tank outlet. The liquid suppressant is then forced out of the tank and against the valve member. Commonly, prior art valves of these types connect to the rest of the fire suppressant system by a 90 degree bend. As such, the liquid suppressant must strike the valve member, turn through the 90 degree bend, and then flow through the pipes of the system to the outlet. Current safety standards can require that the suppressant is dispersed to a desired fire protection area within 10 seconds of the fire event trigger. Therefore, time is of the essence in the release of the suppressant.

### SUMMARY OF THE INVENTION

In one aspect, it has been found that the peripheral edge joint weld of the two-piece holder rupture disc assembly can create an undesired variance in the burst pressures of the rupture discs due to the radially directed energy along the rupture disc that is generated during the welding process. Moreover, since the weld is exposed on the outer peripheral surface of the rupture disc assembly, any defects in the weld can create leakage issues.

Accordingly, the rupture disc valve device herein has a valve body with a solid outer surface such that there are no potential leakage paths to the radial outer periphery of the device. To this end, the welds between the disc and the valve body and the components of the value body are radially inward from the radially outer surface of the valve body. In a preferred form, the rupture disc has its frangible dome wall portion disposed in a linear throughbore of the valve body in a reverse-acting orientation so that the convex side of the dome wall portion of the disc is oriented toward the inlet of the valve body. In this manner, the pressure of the process media generates compressive forces in the radially inward weld joint which contributes to the sealing effect achieved thereby. This also allows the weld joint between the rupture disc and the valve body to be less robust while still achieving a proper seal therebetween.

In another aspect, the rupture disc valve device herein is welded so as to be able to achieve consistency in the desired burst pressures thereof. For this, the rupture disc is welded in a direction transverse to the wall thickness thereof and, more preferably, in an axial direction. In this manner, the heat generated during the welding process is not directed along the rupture disc in a radial inward direction toward the central dome portion thereof. Depending on the metallurgical properties of rupture disc, such radially directed heat can create unwanted variances in the desired burst pressures of the rupture disc. With the axially directed welding process herein, such unwanted variances are minimized. Furthermore, because of the previously described ability to create less robust or lower strength weld joints with the reverse-acting arrangement of the preferred rupture disc valve device herein, this further contributes to the lowering of the heat energy needed during the welding process which, in turn, contributes to maintaining desired burst pressures of the rupture disc.

This problem of creating unwanted variances in the desired burst pressures due to radially directed heat along the rupture disc such as generated when creating the weld joint at the outer periphery of the valve body is particularly problematic with rupture discs that have low burst pressure requirements. In the past, it was possible to weld the thicker materials required for high pressure applications via a circumferential butt/groove weld without materially affecting the burst pressures. However, to achieve the full range of pressures including low burst pressure requirements, thinner rupture disc material is required which is more likely to be affected with radially directed welding such as used for generating the peripheral edge joint weld in the prior rupture disc assembly. Thus, the present rupture disc valve device including the method for generating the weld joints thereof is particularly well suited for rupture discs having thinner wall thicknesses such as in the range of approximately 0.001 inches to approximately 0.037 inches for use in low burst pressure applications.

In another form, a rupture disc valve device is provided having a similar valve body with a solid outer surface. In both forms of the rupture disc valve device herein, the valve body can have a two-piece construction including a smaller diameter annular retaining ring member and a larger diameter annular main valve body seat member which are welded together to form a central, linear throughbore extending through the valve body. In the initially described form, the rupture disc is welded to the seat member with the welding performed as previously described. The retaining ring member is then fit in a recessed seating area of the seat member to be welded thereto.

However, with the solid outer surface of the valve body it has also been found that it can be advantageous to weld the rupture disc to the smaller diameter retaining ring member in the alternative form of the rupture disc valve device. Because the configurations of the retaining ring member and the rupture disc allow for tighter welding fixture clamping, a peripheral edge joint type weld can be formed between the outer peripheries of the retaining ring member of the rupture disc without creating issues with variances in the burst pressure of the rupture disc. The reason is that the radially directed heat energy generated during the welding process need not be as great for forming the weld because of the tighter fixturing for the retaining ring member and the rupture disc during the welding process while at the same time forming the weld so that it is sufficient to form a seal between the retaining ring member and the rupture disc.

By a further approach, rupture discs are used in valve assemblies for pressurized systems, such as fire suppressant systems that utilize a pressurized suppressant and require the controlled release of the pressurized suppressant. Herein, a rupture disc within the valve assembly is configured to burst at a predetermined pressure that is less than a pressure at which the suppressant is stored. By controlling when the rupture disc is permitted to burst despite being exposed to pressures above its rated burst pressure, the valve assembly can effectively and efficiently provide controlled release of the suppressant. Further, use of a rupture disc can advantageously provide an uninterrupted, linear flow path through the valve assembly, which avoids the impeded flow of prior art assemblies. Rupture disc valve assembly configurations are described herein that release the suppressant faster than prior art systems that utilize a valve member that is disposed within the flow path and require a 90 degree bend to connect the tank and valve assembly to the rest of the fire suppressant system.

In one form, a dual rupture disc valve assembly as described herein can be utilized as part of pressurized system, such as a fire suppressant system. The use of rupture discs within a valve assembly advantageously allows for the uninterrupted, linear flow of the suppressant from the suppressant tank to the pipes of the fire suppressant system.

Accordingly, a dual rupture disc valve assembly as described herein includes a valve body having upstream and downstream rupture discs disposed therein. The upstream and downstream rupture discs can be securely welded by any of the configurations described herein utilizing a valve body seat portion and a retaining ring member or portion, such that both the upstream and downstream rupture discs are welded so as to be able to achieve consistency in the desired burst pressures thereof.

As previously set forth, a suppressant tank of a fire suppressant system can be pressurized with a propellant gas. In one aspect, the upstream and downstream rupture discs are configured to each have a burst pressure that is less than the pressure in the tank. As such, without other forces acting on the valve assembly and tank, the pressure within the tank will sequentially rupture the upstream and downstream rupture discs and release the suppressant to the system. Advantageously, the chamber within the valve body between the upstream and downstream rupture discs can be pressurized to support the upstream rupture disc against rupture, such that with the added back pressure, the upstream rupture disc effectively contains the pressurized suppressant and gas within the tank. With this configuration, the upstream rupture disc seals the tank and does not require that the valve body be maintained with a higher back pressure than the pressure within the tank, such as with prior art piston valves. For operation, the chamber between the rupture discs can include one or more discharge ports that, in response to a fire event trigger, discharge the pressure within the chamber, allowing the pressure within the tank to burst the upstream and downstream rupture discs.

In another form, it has been found that a rupture disc and support plate valve assembly as described herein can be utilized as part of a pressurized system, such as a fire suppressant system, as set forth above. The rupture disc and support plate valve assembly can advantageously use a movable support plate to brace a rupture disc blocking flow through the valve assembly. The support plate can be held in place bracing the rupture disc by a retractable member. So configured, when release of the suppressant is desired, the member can be retracted, which allows the support plate to move freely and the pressurized suppressant can burst the rupture disc to flow through the valve assembly and into the fire suppressant system.

In another form, the valve device can include a valve body and two pivotable support members pivotably coupled to the valve body. The support members include an upstream, primary member and a downstream, secondary member that pivot between a first position in a stacked relation extending transverse to a flow path through the valve assembly and a second position extending downstream generally along the flow path. In the first position, the primary support member extends along and braces the rupture disc blocking flow through the valve assembly and the secondary support member extends along and braces the primary support member. The secondary support member is retained or kept in the first position by an actuator having a release. Configuring the two support members to distribute the forces created by bracing the rupture disc advantageously reduces the forces on the release as compared to a single support member.

### BRIEF DESCRIPTION OF THE DRAWINGS

FIG. 1 is a schematic view of the rupture disc valve device showing a rupture disc welded to a valve body;

FIG. 2 is a plan view of the rupture disc valve device showing the annular configuration of the valve body thereof;

FIG. 3 is a cross-sectional view taken along line 3-3 of FIG. 2;

FIG. 4 is an exploded, cross-sectional view of the rupture disc valve device showing a retaining ring member, and a subassembly of a main seat member having the rupture disc welded thereto;

FIG. 5 is an enlarged cross-sectional view of the weld joint between the seat member and the rupture disc shown in FIG. 4;

FIG. 6 is an enlarged cross-sectional view showing the retaining ring member welded to an upstanding annular wall portion of the seat member;

FIG. 7 is a cross-sectional view of the rupture disc valve device clamped in a reverse-acting orientation between inlet and outlet flanged members;

FIG. 8 is an enlarged cross-sectional view of an alternative rupture disc valve device showing a rupture disc welded to a valve body;

FIG. 9 is a cross-sectional view of a subassembly of the rupture disc valve device of FIG. 8 showing the rupture disc welded to the retaining ring member;

FIG. 10 is a schematic view of a prior art rupture disc valve assembly showing a two-piece valve body and rupture disc sealed at an outer peripheral weld joint therebetween;

FIG. 11 is a cross-sectional view of a first embodiment for a rupture disc valve assembly showing upstream and downstream rupture discs welded to a valve body;

FIG. 12 is a cross-section view of the rupture disc valve assembly of FIG. 11 threadedly coupled to a fire suppressant tank;

FIG. 13 is a cross-sectional view of an annular, upstream member of the valve body of FIG. 11;

FIG. 14 is a cross-sectional view of an annular, main valve seat member of the valve body of FIG. 11;

FIG. 15 is a cross-sectional view of an annular, downstream retaining ring member of the valve body of FIGS. 11;

FIG. 16 is a cross-sectional view of an alternative annular, upstream member of the valve body of FIG. 11

FIG. 17 is a perspective view of a second embodiment for a rupture disc valve assembly including a valve body having an inlet conduit and a housing showing a rupture disc of the inlet conduit and a support plate of the housing in a non-support position pivoted away from the rupture disc;

FIG. 18 is a side elevational view of the rupture disc valve assembly of FIG. 17;

FIG. 19 is a cross-sectional view of the rupture disc valve assembly of FIG. 17 taken along the line 19-19 in FIG. 18 showing the support plate in a first position bracing the rupture disc and showing a pressurized tank coupled thereto;

FIG. 20 is a side elevational view of the rupture disc valve assembly of FIG. 17 in an open configuration;

FIG. 21 is a cross-sectional view of the rupture disc valve assembly of FIG. 17 taken along the line 21-21 in FIG. 20 showing the support plate in a non-support position, pivoted away from the rupture disc;

FIG. 22 is a top perspective view of a third embodiment for a rupture disc valve assembly including a valve body with an inlet conduit and a housing showing a rupture disc of the inlet conduit including a pressure relief portion and a support plate of the housing in a non-support position, pivoted away from the rupture disc including a through opening configured to align with the pressure relief portion;

FIG. 23 is a bottom perspective view of the rupture disc valve assembly of FIG. 22 showing atomizing throughbores of the inlet conduit;

FIG. 24 is a cross-sectional view of a rupture disc valve assembly showing a support plate in a non-support portion, pivoted away from the rupture disc, a tank secured to the rupture disc valve assembly, and a solenoid in communication with the rupture disc valve assembly;

FIG. 25 is a cross-sectional, side elevation view of a fourth embodiment for a rupture disc valve assembly including a valve body with an inlet conduit and a housing showing a rupture disc of the inlet conduit including a pressure relief portion and two support members of the housing in a first, bracing position;

FIG. 26 is a cross-sectional, side elevation view of the rupture disc valve assembly of FIG. 25 showing the two support members in a second, open position;

FIG. 27 is a cross-sectional, side elevation view of a rupture disc valve assembly showing an inlet conduit, a housing, and a ring member captured between the inlet conduit and the housing;

FIG. 28 is a bottom perspective, exploded view of the rupture disc valve assembly of FIG. 25;

FIG. 29 is a top perspective view of a support assembly for the rupture disc valve assembly of FIG. 25 showing the two support members being kept in the first position by an actuator;

FIG. 30 is a top perspective view of a primary support member for the rupture disc valve assembly of FIG. 25;

FIG. 31 is a top perspective view of a secondary support member for the rupture disc valve assembly of FIG. 25; and

FIG. 32 is a sectional, side elevation view of the two support members and actuator of FIG. 29.

### DETAILED DESCRIPTION OF THE PREFERRED EMBODIMENTS

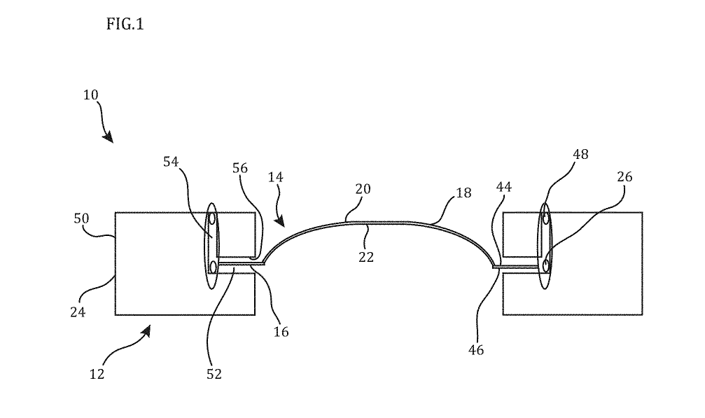

FIG. 1 shows a rupture disc valve device 10 having a valve body 12 and a rupture disc 14 secured thereto. The rupture disc 14 has a flat, outer ring portion 16 and a central, frangible dome wall portion 18 at the radial center of the rupture disc 14. The central dome wall portion 18 of the rupture disc 14 has a convex surface 20 and a concave surface 22 which can have a constant thickness therebetween. The frangible dome wall portion 18 is configured to rupture at a predetermined burst pressure depending on several factors relating to its configuration including the thickness of the dome wall portion 18 and the amount, type and configuration of any scoring provided in either or both of the convex and concave surfaces 20, 22 thereof.

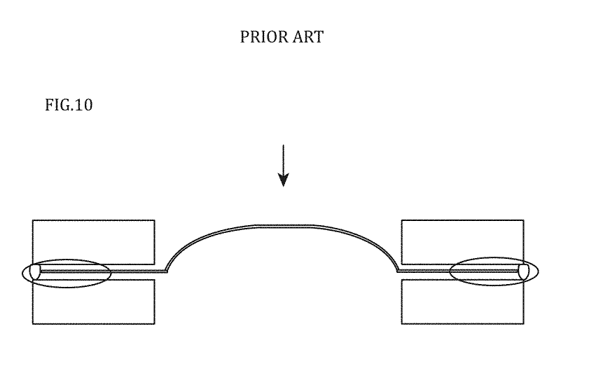

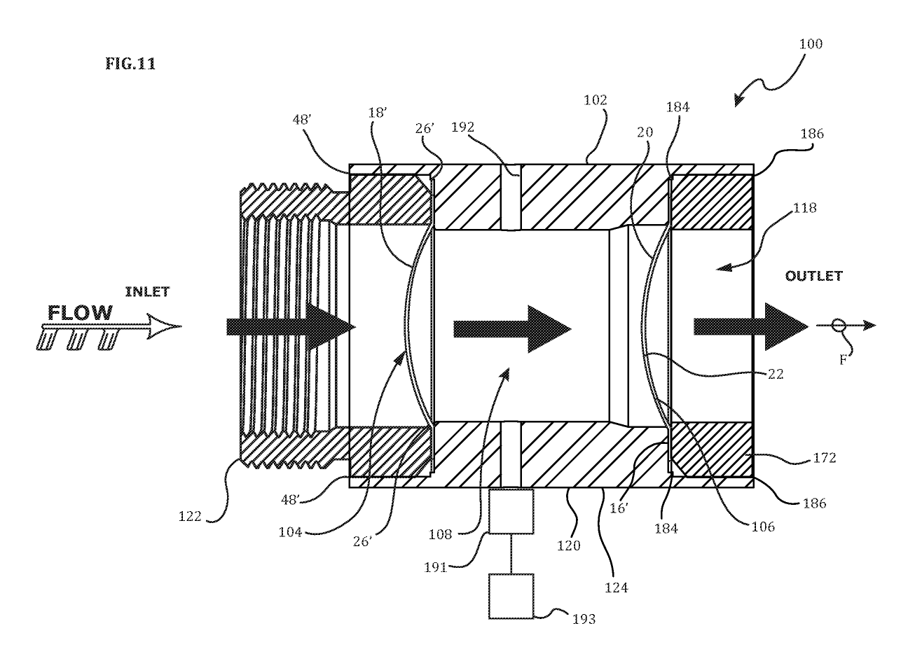

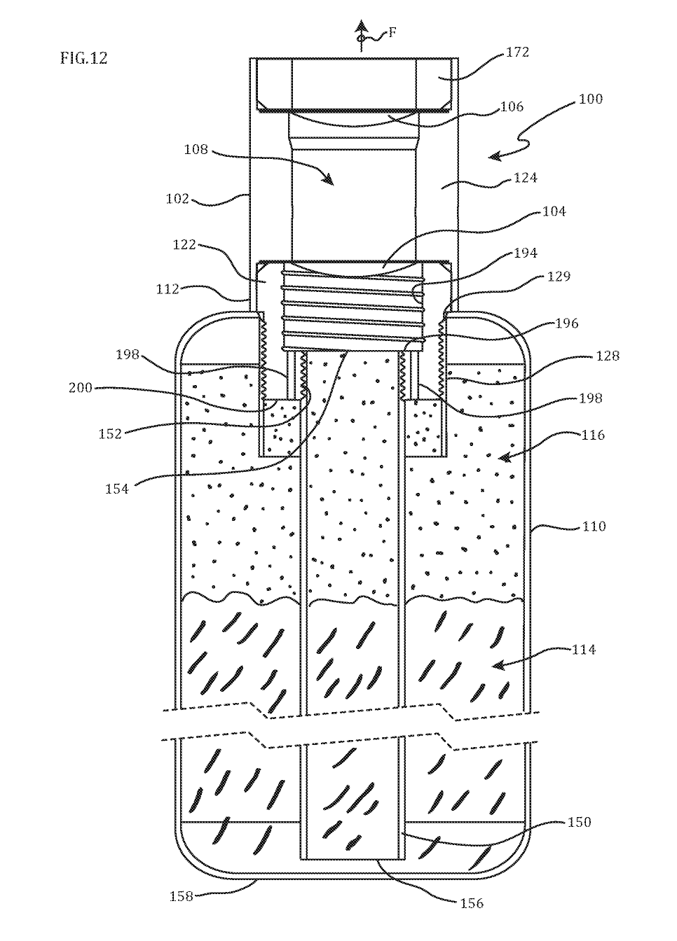

As can be seen, the valve body 12 has a radially outer surface 24 and the rupture disc 14 is secured to the valve body 12 via a weld joint 26 that is spaced radially inward from the valve body outer surface 24 so as not to be exposed thereat. By contrast and referencing FIG. 10, the prior rupture disc valve assembly had a two-piece valve body and a rupture disc sandwiched therebetween with a weld joint formed at the outer peripheral surface of the valve body. Thus, when used in a reverse-acting configuration where the convex surface of the central dome portion of the rupture disc is oriented toward the inlet and exposed to the process media as indicated by arrow showing the flow path through the valve assembly, the pressure thereof generated radially directed outward forces on the weld joint creating the potential for failure of the seal provided thereby. However, with the radially inner weld joint 26 provided between the rupture disc 14 and the valve body 12, any such radially outward directed forces on the weld joint 26 puts the weld joint 26 into a compressive state due to the material of the valve body 12 radially outward therefrom, as will be described further hereinafter.

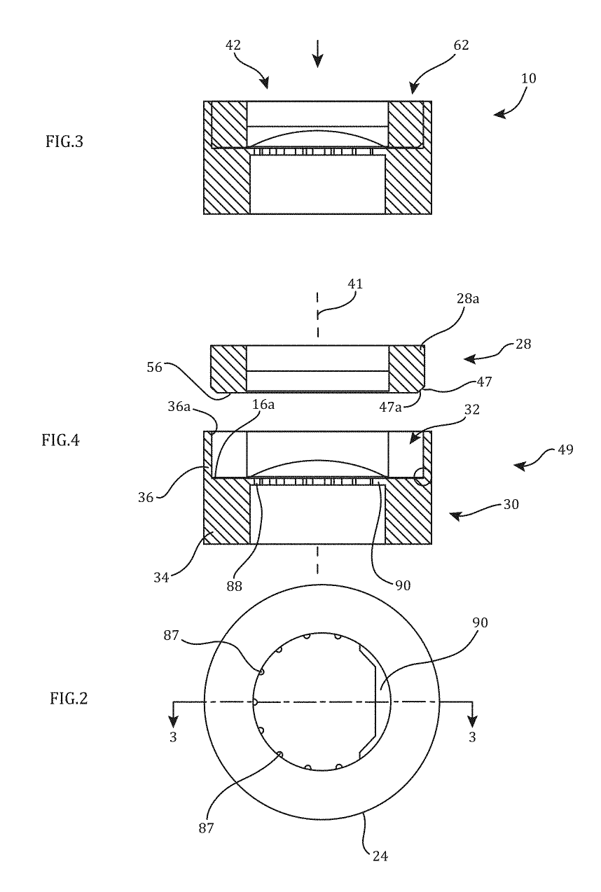

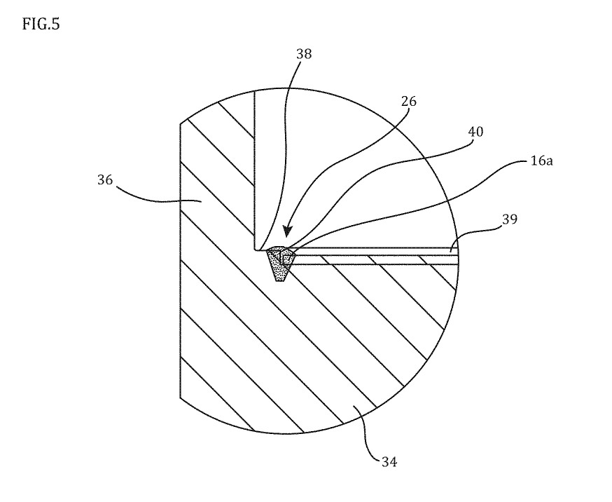

Referring to FIGS. 2-4, it can be seen that the preferred rupture disc valve device 10 has an annular configuration such that the valve body outer surface 24 has a circular cross-sectional shape and the valve body 12 has a linear throughbore 42 extending therethrough. The valve body 12 is preferably a two-piece valve body 12 including an annular retaining ring member 28 and an annular main valve body seat member 30 that are welded together to form the linear throughbore 42 extending therethrough. The main seat member 30 has a recessed seating area 32 in which the rupture disc 14 and the retaining ring member 28 are received. More specifically, the main seat member 30 has an annular body portion 34 and an upstanding, axially extending outer annular wall portion 36 with an annular shoulder surface 38 formed therebetween. The shoulder surface 38 has a recessed annular pocket 39 formed therein having an axial step surface 40 extending therearound.

The flat, outer ring portion 16 of the rupture disc 14 is located in the pocket 39 to be welded to the seat member 30 at the circular outer periphery 16a of the ring portion 16 so that the ring portion 16 at the outer periphery 16a thereof is fused to the material of the main seat member 30 along the shoulder surface 38, recessed pocket 39 and the axial step surface 40 thereof to form the weld joint 26 therebetween. Because the pocket 39 is radially inward from the upstanding annular wall portion 36, radial clearance is provided for the axial weld beam for forming a lap joint weld between the rupture disc 16 and the seat member 30 as well as for providing more metallic material to overlay the welded disc ring portion periphery 16a, as shown in FIG. 5. Various welding techniques may be utilized with electron beam welding being one preferred technique used for forming the weld joints described herein. The materials of the valve body 12 including the retaining ring member 28 and seat member 30 and the rupture disc 14 are preferably metallic materials, such as steel and steel alloy materials. For example, the rupture disc material can include 316/316L, C-276, Hastellloy, Monel, Nickel 400, Nickel 600, Nickel 625, Inconel 600, Inconel 625, Nickel 200/201, Titanium, Tantalum, A-36, and 1018. The metallic material of the rupture disc 14, retainer ring member 28 and seat member 30 can be the same or different from each other, although typically the valve body members 28 and 30 will be the same material.

To weld the outer periphery 16a of the rupture disc ring portion 16 in the recessed pocket 39, the weld beam is directed in a generally axial direction along axis 41. As shown, axis 41 extends generally through the central throughbore 42 of the rupture disc valve device 10. Because the heat generated by the welding process is directed in a transverse and, more specifically, perpendicular direction to the thickness of the outer ring portion 16 between the upper and lower surfaces 44 and 46 thereof, heat energy conducted radially inward to the dome wall portion 18 of the rupture disc 14 is kept to a minimum. In this manner, generating the weld joint 26 as described does not also create unwanted variances in the desired burst pressure of the rupture disc 14. This is particularly true with thinner rupture discs 14 such as on the order of approximately 0.001 inches to 0.037 inches in thickness. Such thinner rupture discs 14 are more sensitive to the effects of heat on the metallurgical properties of the disc 14, and particularly the frangible dome wall portion 18 thereof.

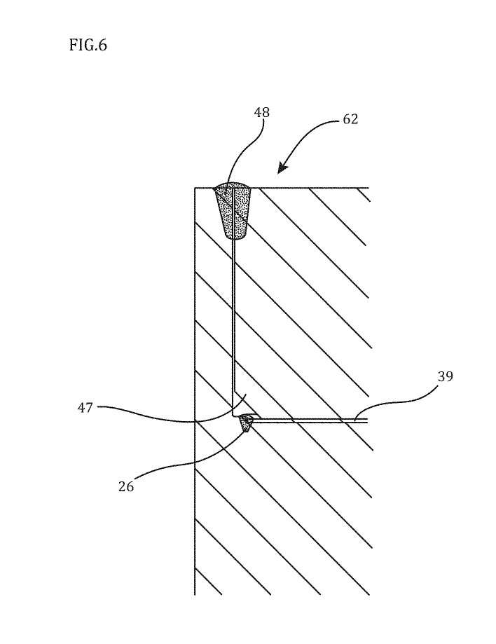

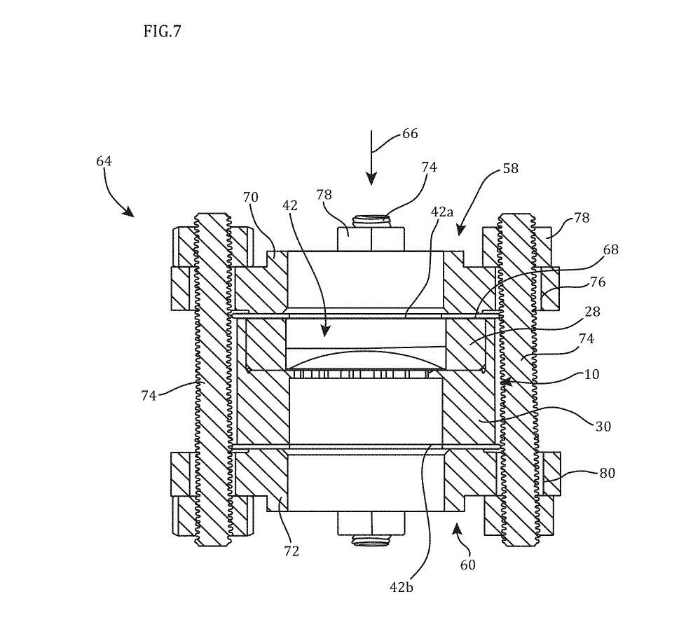

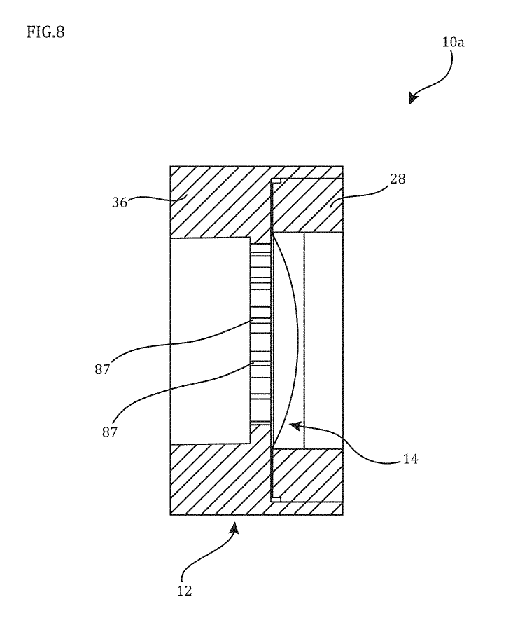

After welding of the rupture disc 14 to the seat member 30 to form subassembly 49, the assembly of the rupture disc valve device 10 proceeds by welding of the retaining ring member 28 of the subassembly 49 so that the subassembly 49 is disposed and secured in the recessed seating area 32 of the seat member 30. The retainer ring member 28 has an outer diameter that is in clearance with the diameter across the recessed seating area 32 formed by the upstanding annular wall portion 36 as to be able to fit within the recessed seating area 32, as shown in FIGS. 1 and 3. Along its lower outer corner 47 the ring member 28 is chamfered so that when fit within the seating area 32, the ring member 28 does not engage and place loading directly on the welded joint 26 between the disc ring portion 16 and the seat member 30, as can be seen in FIG. 6.

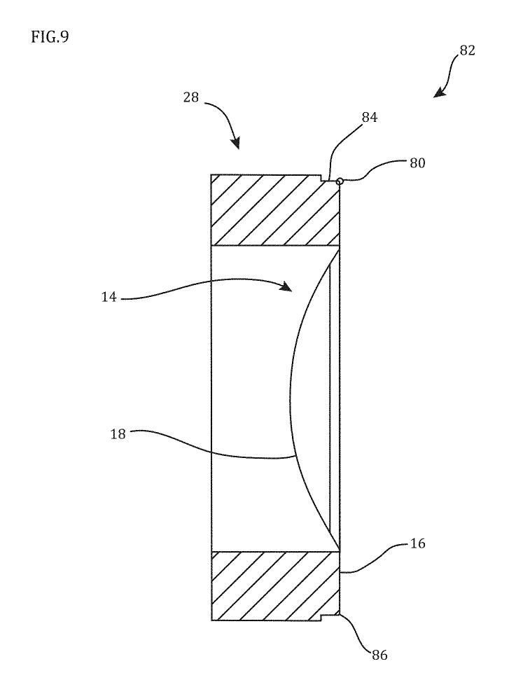

The retaining ring member 28 is welded to the seat member 30 at the upper outer corner 28a of the ring member 28 and the upper inner end 36a of the upstanding wall portion 36 to form weld joint 48 therebetween, as shown in FIG. 1. The weld joint 48 is axially spaced from the weld joint 26 and slightly radially misaligned or offset from the weld joint 26 so that it is radially outward therefrom. Comparing FIG. 1 to FIG. 10, it can be seen that the present rupture disc valve device 10 has multiple weld joints 26 and 48 versus the single weld joint of the prior disc valve assembly. This is advantageous in that the weld joint 26 need only be formed to fuse two components together, namely the rupture disc 14 and the seat member 30, to provide a sealed connection therebetween without the need for the weld joint 26 to also provide structural support against the loading experienced by the valve device 10 during its installation and when it is in service. This enables a lower weld depth for weld joint 26 to be utilized while still achieving a proper seal between the rupture disc 14 and the seat member 30. By contrast, the second weld joint 48 is considered a structural weld to keep the valve body members 28 and 30 securely connected, and thus is preferably formed to be larger and deeper than weld joint 26, as depicted in FIG. 6. In this regard, since the weld joint 26 need not be as robust as either the weld joint 48 or the weld joint for the prior disc valve assembly of FIG. 7, the heat energy generated during the welding thereof can be lower and thus less impactful on the intended burst pressures of the rupture disc 14, particularly with thinner rupture discs 14 as previously discussed.

With the rupture disc valve device 10, all potential pathways for leakage are formed entirely radially inward of outer surface 50 of the valve body 12. In this manner, any leakage pathways are all contained within the valve body 12, so that they are not exposed to the exterior thereof along the radially outer surface 50 of the valve body 12. In particular, the leakage pathway of valve body 12 includes traversely extending sections with a radial pathway section 52 and an axial pathway section 54. The radial pathway section 52 is along the rupture disc ring portion 16 between bottom surface 56 of the retaining ring member 28 and recessed pocket 39 of the seat member 30. The radial pathway section 52 is sealed by the weld joint 26. Also, when installed as shown in FIG. 7, the clamping pressure exerted by the clamped flanged members 58 and 60 such as flanged pipes will seal the retaining ring member 28 against the facing surface 44 of the disc outer ring portion 16 since the retaining ring member 28 is oriented such that its bottom surface 56 is in recessed pocket 39 engaged with the disc ring portion surface 44. In addition, even if there is leakage along the radial pathway section 52 such as due to an imperfect weld joint 26, the process media will not escape to the surrounding work areas since neither the radial pathway section 52 nor the axial pathway section 54 are exposed to the outer surface 50 of the valve body 12. Any leakage of the media through the radial pathway section 52 and past the seal formed by the weld joint 26 will still be blocked from leakage to the outer surface 50 by the weld joint 48 at the end of the axial pathway section 54. Thus, the leakage pathway for the rupture disc valve device 10 is a non-linear or tortuous pathway including transverse sections 52 and 54 thereof further minimizing potential leaks therefrom.

Once the rupture disc valve device 10 is welded together as described above, the weld 48 and the annular axial end surface 62 of the valve body 12 are machined to a desired surface finish for providing a smooth seal surface for installation of the valve device 10. More specifically and referring to FIG. 7, the rupture disc valve device 10 is shown installed in its reverse-acting orientation with flow through the bolted flanged assembly 64 indicated by arrow 66 such that the frangible dome wall portion 18 has its convex side or surface 20 facing inlet 42a of the valve linear throughbore 42 formed by the retaining ring member 28 and its concave side or surface 22 facing outlet 42b of the valve linear throughbore 42 formed by the main seat member 30. For installation a ring gasket member 68 is placed on the machined axial end surface 62 so as to seat flush thereon. Thereafter, annular flanges 70 and 72 are aligned adjacent corresponding valve members 28 and 30 and threaded studs 74 are inserted through aligned stud apertures 76 of the flanges 70 and 72 with nuts 78 threaded onto the projecting ends of the studs 76 so as to clamp the flange members 70 and 72 against corresponding axial ends of the valve device 10. The gasket member 68 being tightly clamped by flange 70 against the axial end surface 62 including the weld joint 48 thereat will act to further seal the valve device 10 even if both of the weld joints 26 and 48 experience leakage therearound.

With the valve device 10 in service as illustrated in FIG. 7, the forces acting on the rupture disc 14 aid in the sealing function provided by the weld joint 26 as the convex side 20 of the frangible dome wall portion 18 is exposed to the pressure of the process media. As previously discussed, this creates a radial outwardly directed force in the ring portion 16 of the rupture disc 14 which urges the weld joint 26 more firmly against the axial step surface 40 in the pocket 39 improving the sealing provided thereby. And as previously mentioned, the weld joint 26 does not experience any other loading as the retaining ring member 28 has a corner chamfer 47 to extend obliquely to the retaining member bottom surface 56 providing clearance for the weld joint 26 so as to remove any direct loading thereon from the clamping force generated by the bolted flange assembly 64. As can be seen in FIG. 6, the retaining ring member 28 can be sized to extend into the pocket 39, albeit in clearance with the weld joint 26 extending along the pocket axial step surface 40 due to the chamfered corner 47 of the retaining ring member 28.

In another embodiment, valve device 10a as shown in FIG. 8 is provided which is similar to the previously-described valve device 10 such that the same reference numbers will be used for their corresponding components. The valve device 10a also preferably has a two-piece valve body 12 having the rupture disc 14 welded thereto. However, the rupture disc 14 is welded to the retaining ring member 28, as opposed to the seat member 30. As shown in FIG. 9, the rupture disc 14 is fitted directly to the retaining ring member 28 with their respective outer diameters aligned, and the rupture disc ring portion 16 seated flush against ring member bottom 56 for forming a peripheral edge joint type weld 80 (illustrated schematically) that seals the rupture disc 14 and the retaining ring member 28 together and forms subassembly 82.

In this regard, the ring member 28 of the valve device 10a does not include a chamfered outer, lower corner like the previously described ring member 28 of the valve device 10, but instead has an annular groove 84 formed at the outer, lower corner 86 with the corner 86 having substantially the same diameter as the outer periphery 16a of the rupture disc ring portion 16. The valve device 10a avoids creating undesired variances in the burst pressure of the rupture disc 14 when using radially directed heat energy for forming the peripheral weld 80 because of the easy capability to tightly line-up the outer periphery of the rupture disc 14 and the ring member 28 during welding. This results in being able to form the peripheral weld joint 80 to have effective sealing capabilities while at the same time requiring lower amperage (i.e., reduced heat) for its formation. Given that lower burst pressures, e.g., approximately 50 psi and below, require thinner rupture discs, which are more easily stressed, the lower amperage needed for the peripheral weld 80 reduces potential defects of the rupture disc 14. The ease of use of the fixturing for forming the welded subassembly 82 also allows for fast and efficient manufacturing of the rupture disc device 10a.

Furthermore, each of the weld joints 48 and 80 in the rupture disc valve device 10a remain disposed radially inward from the outer surface 50 of the valve body 12, and specifically the radially larger seat member 30 thereof such that the valve device 10a generally has the same transversely extending leakage pathway sections 52 and 54 as the previously described valve device 10. Therefore, any defects due to stress pressure on the peripheral weld 80 that may result in leakage will still be contained by the weld joint 48 between the retaining ring member 28 and the seat member 30.

To complete the valve device 10a, the subassembly 82 is secured to the seat member 30 by creating the weld joint 48 between the upper corner 28a of the ring member 28 having the rupture disc 14 already welded thereto and the upper, inner end 36a of the upstanding wall portion 36 of the seat member 30. The rupture disc valve device 10a can then be clamped in a reverse-acting orientation between inlet and outlet flanged members 58 and 60 in the same manner as shown in FIG. 7.

In both valve devices 10 and 10a, the seat member 30 can have cutting elements 87 formed to be spaced circumferentially about the upper, inner edge portion 88 of the annular body portion 34 thereof. The cutting elements 87 assist with the rupture of dome wall portion 18 of the rupture disc 14 when the process media in the valve body 12 reaches the predetermined burst pressure of the rupture disc 14. As best seen in FIG. 2, a segment shaped portion 90 projects from the edge portion 88 and provides a fulcrum about which the burst dome wall portion 18 bends when it is ruptured so that the dome wall portion 18 stays attached to the outer ring portion 16 after it is burst and bent.

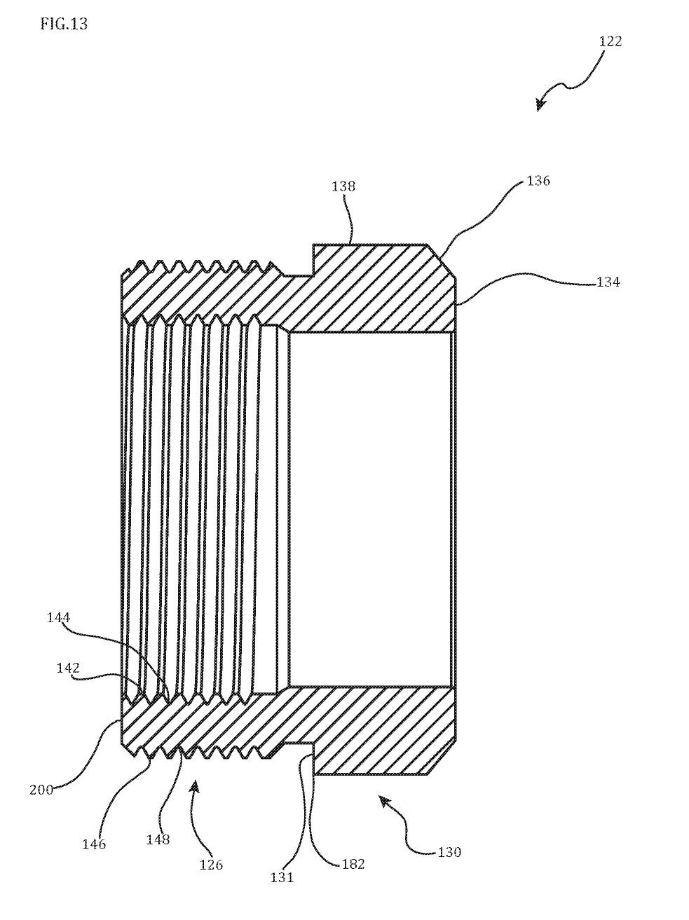

FIG. 11 shows a dual rupture disc valve device or assembly 100 that can accommodate multiple pressure ranges for a variety of fire suppressant systems. The dual rupture disc valve assembly 100 includes a generally annularly configured valve body 102, an upstream rupture disc 104, and a downstream rupture disc 106, that together define a chamber 108 therebetween. The valve assembly 100 is configured to be secured to a fire suppressant tank 110 at an upstream end portion 112 thereof. As previously discussed, the fire suppressant tank 110 can be configured to store a fire suppressant liquid 114 and gas 116 in a pressurized state therein, such that, upon opening of the valve assembly 100, the suppressant 114 is expelled from the tank 110, through the valve assembly 100, and to the rest of a fire suppressant system downstream therefrom. As shown, the valve assembly 100 has a linearly configured throughbore 118 extending along a flow axis F, such that the suppressant 114 travels along a linear flow path when exiting the tank 110 from the upstream or inlet end portion 112 of the valve body 102 to a downstream or outlet end portion 172 thereof. Moreover, by virtue of the operation of the rupture discs 104 and 106, the linear flow path is substantially unimpeded by any components of the valve assembly 100. So configured, the flow axis F can be, in a preferred form, aligned with a longitudinal axis L of the tank 110. The assembly 100 includes components configured similarly to those described above, such that the same reference numbers will be used for their corresponding components with the addition of a prime.

The upstream and downstream rupture discs 104 and 106 can be configured as described above, including the flat, outer ring portion 16′ and central, frangible dome wall portion 18′ at the radial center of the rupture discs 104 and 106. Further, the upstream and downstream rupture discs 104 and 106 can be secured to the valve body 102 utilizing similar methods and configurations as described above.

In one aspect, the upstream rupture disc 104 is secured to the valve body 102 in a similar configuration as that shown in FIGS. 1-4. As such, the upstream rupture disc 102 is secured to the valve body via a weld joint 26′ that is spaced radially inward from an outer surface 120 of the valve body 102 so as not to be exposed thereat. The valve body 102 is preferably a multiple piece assembly including an annular, upstream member 122 and an annular main valve body seat member 124. The upstream member 122 includes an annular, threaded coupling portion 126 at one end thereof configured to threadedly secure the valve assembly 100 to a cooperating threaded coupling portion 128 of the tank 110. The threaded connection between the upstream member 122 and the tank 110 can further include an O-ring 129 disposed therebetween. The upstream member 122 further includes an annular, retaining ring portion 130 at an opposite end thereof, similar to the retaining ring member 28′ discussed above, and an upstream facing annular shoulder surface 131 extending between the retaining ring portion 130 and the threaded coupling portion 126 such that the ring portion 130 is radially larger than the coupling portion 126.

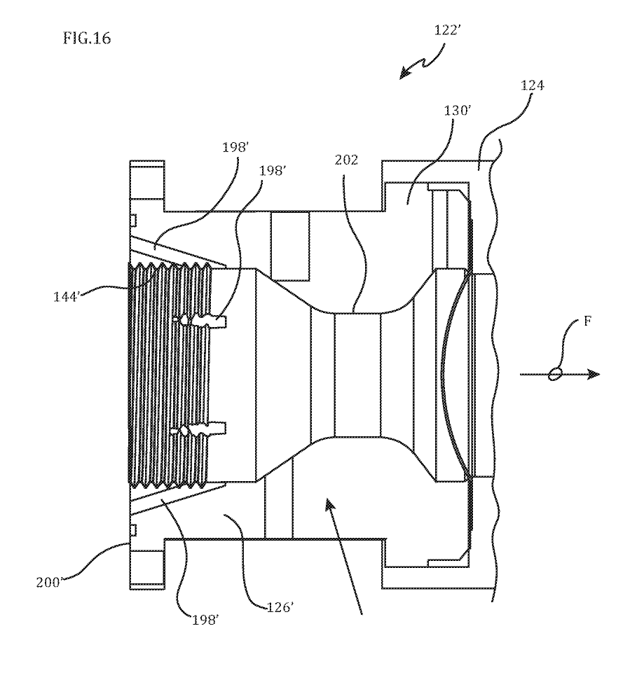

As shown in FIG. 14, the seat member 124 includes an upstream seat portion 132 configured similarly to the seat member 30′ discussed above. As such, the upstream seat portion 132 includes the annular body portion 34′ and the upstanding, axially extending outer annular wall portion 36′ with the annular shoulder surface 38′ formed therebetween. The shoulder surface 38′ further can have the recessed annular pocket 39′ formed therein having the axial step surface 40′ extending therearound. So configured, the retaining ring portion 130 of the upstream member 122 can be inserted into the upstream seat portion 132 of the seat member 124 with the flat, outer ring portion 16′ of the upstream rupture disc 104 captured between an end surface 134 of the upstream member 122 and the recessed annular pocket 39′ of the upstream seat portion 132. Moreover, the upstream rupture disc 104 and the seat member 124 can be welded together as has previously been described above. As with the above embodiments, a corner 136 of the retaining ring portion 130 can be chamfered to extend obliquely between an outer surface 138 thereof and the downstream end surface 134 thereof to provide clearance for the weld joint 26′.

As shown in FIG. 11, the threaded coupling portion 126 includes an interior thread 142 on an interior cylindrical surface 144 thereof and an exterior thread 146 on an exterior cylindrical surface 148 thereof. So configured, the exterior thread 146 is configured to couple to the cooperating threaded coupling portion 128 of the tank 110. The interior thread 142, meanwhile, is configured to couple to an elongate siphon member 150 having a threaded portion 152 at a first end 154 thereof. The siphon member 150 extends within the tank 110 from the first end 154 to a second end 156 thereof that is spaced from an end wall 158 of the tank 110, which as shown can be closely adjacent thereto.

The downstream rupture disc 106 can be secured to the valve body 102 with a similar configuration as described above, albeit with the downstream rupture disc 106 in an opposite orientation relative to the seat and retaining ring. As shown in FIG. 11, the seat member 124 further includes a downstream seat portion 160. The downstream seat portion 160 includes an annular body portion 162 and an upstanding, axially extending outer annular wall portion 164 with a downstream facing annular shoulder surface 166 formed therebetween. Further, the shoulder surface 166 can have a recessed annular pocket 168 formed therein with an axial step surface 170 extending therearound.

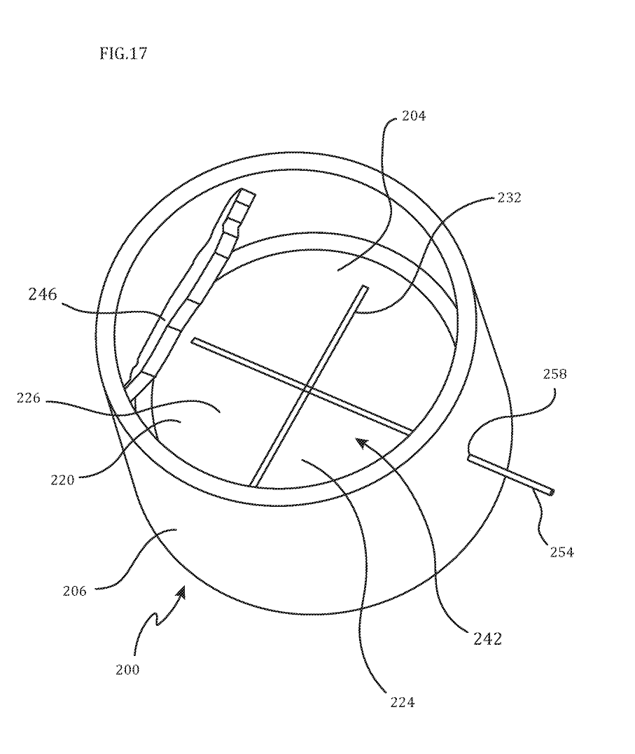

The valve body 102 can further include a downstream retaining ring member or portion 172, shown in FIGS. 11 and 15. Although the retaining ring member 172 is shown in the figures as a standalone component, it can include a downstream connection portion, utilizing threads, adhesive, or other suitable methods, to connect the valve body 102 to a downstream pipe as desired. By another approach, the main seat member 124 can be configured to connect to a downstream pipe.

As shown in FIGS. 11 and 14, the valve body 102 includes a linearly configured throughbore 118 that, as previously discussed, together with the upstream and downstream rupture discs 104 and 106, defines the chamber 108 in an intermediate portion 174 of the valve body 102 between the upstream and downstream end portions 112 and 172 thereof. As illustrated, the upstream and downstream rupture discs 104 and 106 are reverse buckling-type rupture discs oriented in the flow path with the dome wall portions 18′ thereof projecting downstream into the flow path. When a sufficient pressure acts on the discs, the dome portions 18′ rupture and portions thereof are driven to project downstream within the throughbore 118. As shown in FIG. 14, the throughbore 118 in the intermediate portion 174 of the valve body 102 has an upstream portion 176 adjacent to the upstream rupture disc 104 with a first interior diameter and a downstream portion 178 adjacent to the downstream rupture disc 106 with a second interior diameter larger than the first diameter. The relatively increased diameter of the throughbore 118 in the downstream portion 178 thereof provides clearance for the dome wall portion 18′ of the downstream rupture disc 106 that projects upstream in an arcuate manner. Further, the interior diameter of the downstream retaining ring 172 can be sized to be generally equal to the diameter of the throughbore 118 in the upstream portion 176 thereof such that an interior edge 180 of the retaining ring 172 projects radially inwardly past a connection between the outer ring portion 16′ and the dome wall portion 18′ of the downstream rupture disc 106 which can be sized to support the flat, outer ring portion 16′ of the downstream retaining ring 172.

With this configuration, the valve body 102 and rupture discs 104 and 106 can be assembled to form the dual rupture disc valve assembly 100 as shown in FIG. 11. More specifically, the upstream rupture disc 104 is secured to the seat member 124 via a weld joint 26′, as discussed above. Next, an upstream outer corner 182 of the upstream member 122 between the retaining ring portion 130 and the upstream facing annular shoulder surface 131 thereof is welded to the seat member 124 at an upstream inner end 36a′ of the upstanding wall portion 36′ thereof to form a weld joint 48′ therebetween. As with the above embodiments, the weld joint 48′ can be axially spaced from the weld joint 26′ and slightly radially misaligned or offset from the weld joint 26′ so that it is radially outward therefrom. Next, the downstream rupture disc 106 and downstream retaining ring member 172 can be secured to the seat member 124 via weld joints 184 and 186, configured similarly to the weld joints 26′ and 48′. More specifically, the flat, outer ring portion 16′ of the downstream rupture disc 106 is located in the pocket 168 to be welded to the downstream portion 160 of the seat member 124 at the circular outer periphery 16a′ of the ring portion 16′ so that the ring portion 16′ at the outer periphery 16a′ thereof is fused to the material of the seat member 124 along the shoulder surface 166, the recessed pocket 168, and the axial step surface 170 thereof to form the weld joint 184 therebetween. As shown, an upstream outer corner 187 of the downstream retaining ring member 172 can be chamfered similar to the chamfered corner 47′ described above so that when the ring member 172 is fit within the upstanding wall portion 164, the retaining ring member 172 does not engage and place loading directly on the welded joint 184 between the disc ring portion 16′ and the seat member 124. Further, the downstream retaining ring member 172 is welded to the downstream portion 160 of the seat member 124 at a downstream outer corner 188 of the downstream retaining ring member 172 and a downstream inner edge 190 of the upstanding wall portion 164 to form the weld joint 186 therebetween.

As shown in FIG. 11, the seat member 124 can include one or more radially-extending ports 192 therein. Although two ports 192 are shown, one, or more than two can be used if required or desired for a particular use. The ports 192 radially extend between the seat member outer surface 120 and the flow path throughbore 118 to provide one or more pressure control paths for the chamber 108. After the dual rupture disc valve assembly 100 is constructed as set forth above, the chamber 108 can be pressurized to a predetermined level depending on the fire suppression system requirements, including the tank pressurization and the rupture disc burst pressure ratings. More specifically, the chamber pressurization pushes against the upstream rupture disc 104 so that the upstream rupture disc 104 can withstand the pressure within the tank 110 without bursting. However, the pressure in the chamber 108 is below that of the burst pressure rating for the downstream rupture disc 106. The chamber 108 can be pressurized either during initial assembly of the valve assembly 100 or subsequently thereto, such as when the valve assembly 100 is installed in a fire suppressant system. The pressure within the chamber 108 can be controlled via the ports 192 with a valve 191 and control circuit 193, such as a Schrader valve connected to a solenoid or other suitable mechanisms.

With this assembly and configuration, the dual rupture disc valve assembly 100 can be installed within a fire suppression system. When a fire event triggers the system, the control circuit 193 can cause the valve 191 to depressurize or vent the chamber 108. When the back pressure on the upstream rupture disc 104 in combination with the burst pressure rating of the disc 104 falls below the pressure within the tank 110, the upstream and downstream rupture discs 104 and 106 sequentially burst and the pressurized gas 116 pushes the liquid suppressant through the siphon member 150 of the tank 110 and through the linear flow path of the valve body throughbore 118 into pipes of the fire suppressant system. The rupture discs 104 and 106 as described herein can include any desired amount, type, and configuration of scoring provided in either or both of the convex and concave surfaces 20′, 22′ thereof. So configured, when the rupture discs 104 and 106 burst, portions or petals thereof pivot rearwardly along and through the flow path until they extend along and closely adjacent to the interior surface of the valve body 102 to allow for unimpeded flow through the flow path within the throughbore 118 of the valve body 102. As such, the dual rupture disc assembly 100 as described herein provides an uninterrupted, linear discharge of the fire suppressant with no flow interruptions in the central portion of the throughbore 118, as compared to the interrupting valve member and 90 degree bend provided in prior art piston valves. Moreover, the back pressure required to seal the tank 110 is lower with the dual rupture disc valve assembly 100 described herein, as the back pressure is only required to supplement or reinforce the burst pressure rating of the upstream rupture disc 104, not provide enough back pressure to hold a valve member against the tank as with prior art piston valves.

In one configuration, the upstream rupture disc 104 can have a burst pressure rating between about 80% and about 95% of the pressure within the tank 110, and preferably between about 85% and about 90%. Further, the chamber 108 pressure can have similar percentages as compared to the burst pressure rating of the upstream rupture disc 104. The downstream rupture disc 106 need only have a burst pressure rating greater than the chamber 108 pressure, but can have the same burst pressure rating as the upstream rupture disc 104 or other configurations as desired.

In one example, the tank 110 can be pressurized to about 500 psig, the upstream and downstream rupture discs 104 and 106 can have a burst pressure rating of about 440 psig, and the back pressure within the chamber 108 can be about 380 psig.

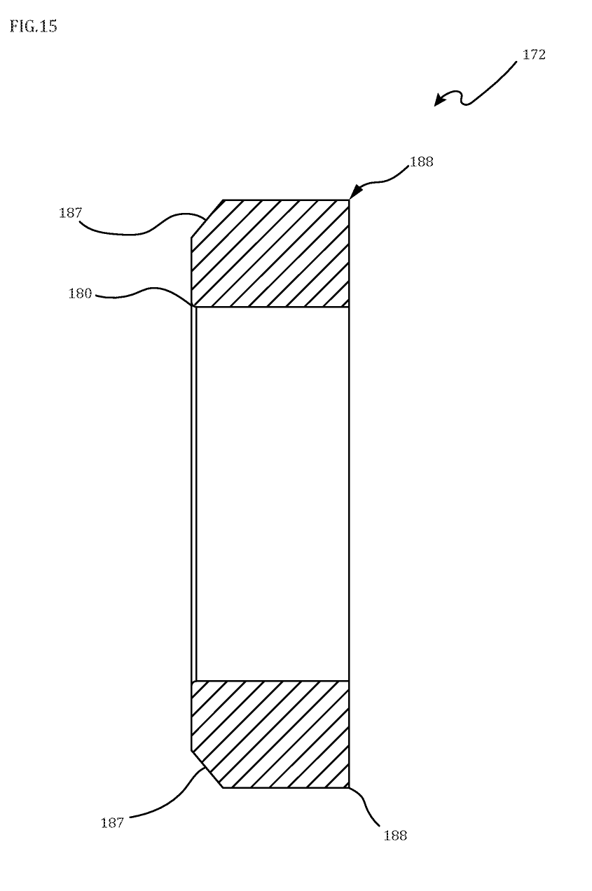

In one example, as shown in FIG. 13, the upstream member 122 can have the following dimensions. The retaining ring portion 130 can have an outer diameter of about 3.7 inches, an inner diameter of about 2.5 inches, and a length of about 1 inch. The chamfered corner 136 can extend about 40 degrees from normal to the flow path axis F. The threaded coupling portion 126 can have an outer diameter of about 3.3 inches and a length of about 1.4 inches. In another example, as shown in FIG. 14, the main seat member 124 can have the following dimensions. The seat member 124 can have an outer diameter of about 4 inches and a length of about 5 inches. The upstanding outer annular wall portions 36′, 164 can have an inner diameter of about 3.7 inches and a length of about 1 inch. The axial step surfaces 40′, 170 can have an inner diameter of about 3.6 inches and the recessed pockets 39′, 168 can be recessed about 0.05 inches. The upstream portion 176 of the intermediate portion 174 can have an inner diameter of about 2.4 inches and the downstream portion 178 of the intermediate portion 174 can have an inner diameter of about 2.5 inches. In yet another example, as shown in FIG. 15, the downstream retaining ring 172 can have an outer diameter of about 3.7 inches and an inner diameter of about 2.4 inches.

The above dual rupture disc valve assembly 100 can be suitable for many applications. With the above configuration, the pressurized gas 116 pushes the liquid suppressant 114 through the fire suppressant system to an outlet, such as a sprinkler head or the like, that atomizes the liquid suppressant 114 to extinguish fire within a protection area. By one approach, the tank 110 can be oriented in an upright configuration resting on the end wall 158 thereof and the dual rupture disc valve assembly 100 positioned vertically above the tank 110. Further, the tank 110 can be partially filled with the liquid suppressant 114, such as about half the volume thereof. The gas 116 is then fed into the tank 110 until a desired pressure is reached. With this orientation and with the second end 156 of the siphon member 150 disposed adjacent to the tank end wall 158, most or all of the liquid suppressant 114 is driven out of the tank 110 before most or all of the gas 116.

By a further approach, the dual rupture disc valve assembly 100 can be configured to atomize the liquid suppressant 114 so that flow through the valve body 102 and the rest of the fire suppressant system is as an atomized gas, rather than the relatively slower liquid suppressant 114.

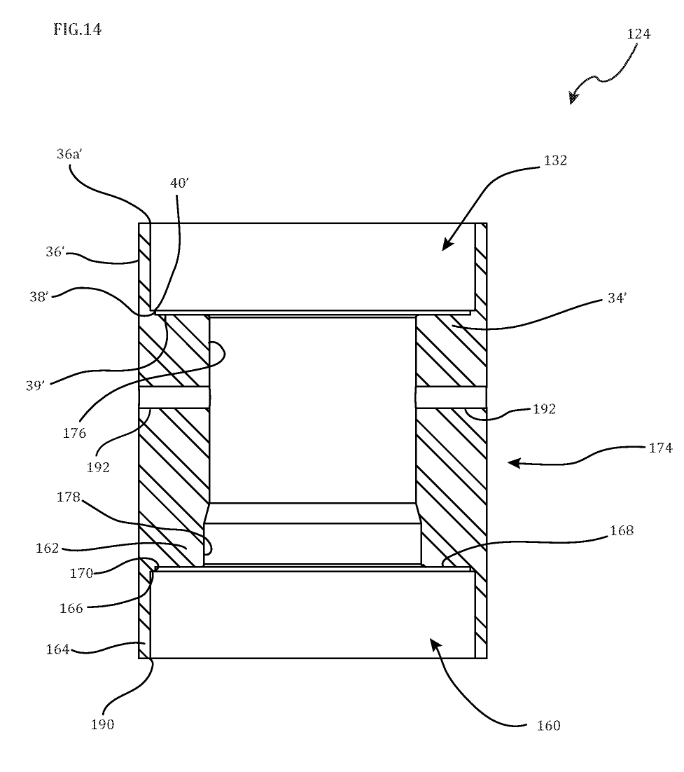

As shown in FIG. 12, the upstream member 122 can include a downstream annular portion 194 having a larger interior diameter than the interior cylindrical surface 144 of the threaded coupling portion 126, such that an interior annular shoulder portion 196 extends therebetween. With this configuration, one or more atomizing throughbores 198 can extend through the upstream member 122 between the annular shoulder portion 196 thereof and an upstream end surface 200 thereof with the throughbore 198 being generally parallel to the flow axis F of the throughbore 118. As illustrated, the atomizing throughbores 198 connect the interior of the upstream member 122 and the tank 110 outside of the siphon member 150 thereof.

So configured, when the pressure of the tank 110 bursts the upstream and downstream rupture discs 104 and 106, the pressurized gas 116 flows through the atomizing throughbores 198 and is injected into the liquid suppressant 114 while the suppressant 114 flows through the upstream member 112 to effectively atomize the liquid suppressant 114. As such, this configuration advantageously utilizes the pressurized gas 116 to not only drive the suppressant 114 through the system, but also to atomize the liquid suppressant 114 so that it can flow through the system at a faster rate.

An alternative configuration for an atomizing upstream member 122′ is shown in FIG. 16. The upstream member 122′ of this form can be welded to the main seat member 124 similarly as described above. As illustrated, the atomizing throughbores 198′ of this form extend radially inwardly at an acute angle with respect to the flow axis F between the upstream end surface 200′ and the interior cylindrical surface 144′ of the threaded coupling portion 126′. The angled orientation of the throughbores 198′ is believed to optimize the injection of the gas 116 directly into the liquid 114 as the materials exit the tank 110 because the throughbores 198′ are inclined from their inlet end to their outlet end toward the center flow axis F of the flow path, which more effectively atomizes the liquid 114. In the illustrated form, the upstream member 122′ includes six throughbores 198′ spaced radially around the threaded coupling portion 126′ thereof. Of course, other configurations, spacing, and amounts can be utilized as required or desired for a particular application.

By another approach, the upstream member 122′ of this form can include a waisted, downstream, annular portion 202 having a smaller interior diameter than the interior cylindrical surface 144′ of the threaded coupling portion 126′ and the interior diameter of the retaining ring portion 130′. It is believed that this convergent-divergent flow path within the upstream member 122′ increases velocity of the fire suppressant material through the valve assembly 100.

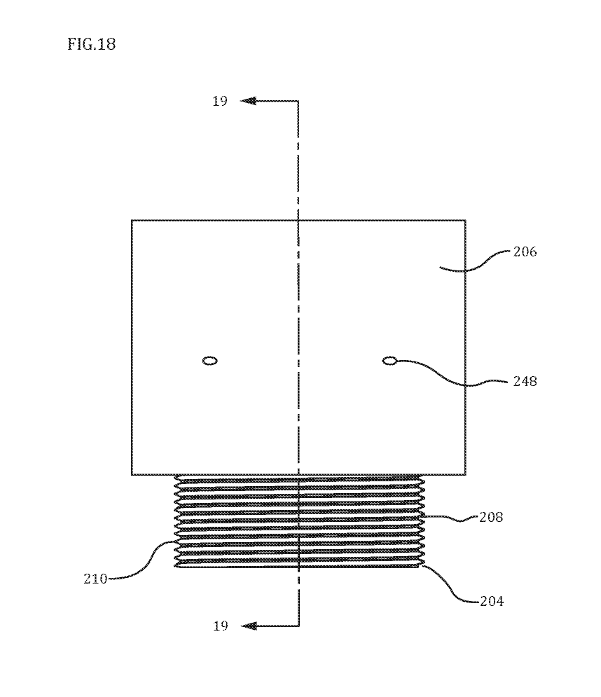

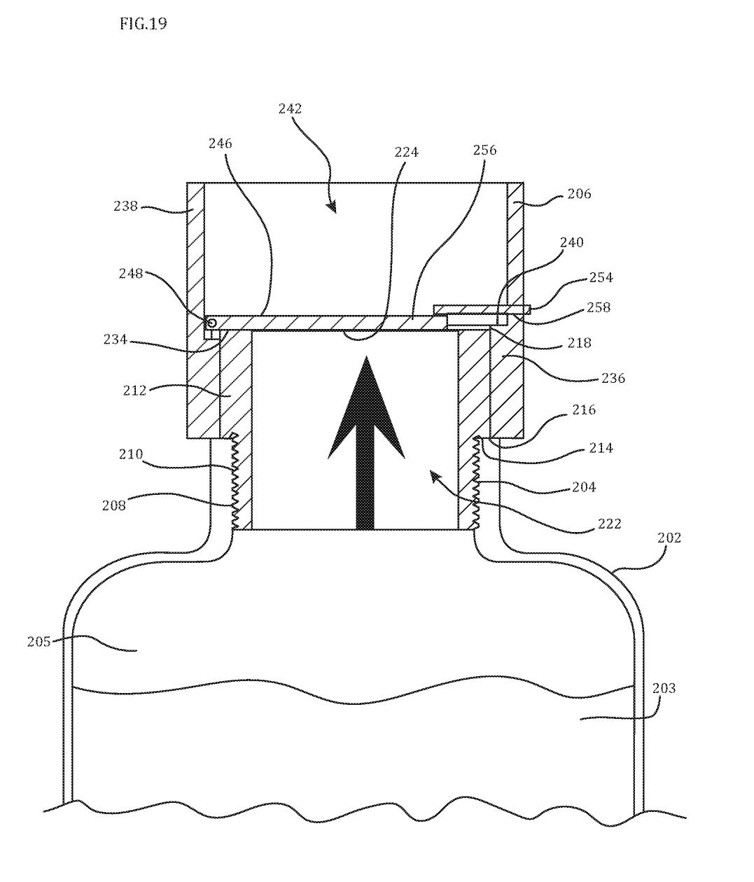

A rupture disc valve assembly 200 for a pressurized system, such as a fire suppressant system, is shown in FIGS. 17-21. The rupture disc valve assembly 200 of this form is mounted to a pressurized component or system, such as a tank 202 as shown in FIG. 19. The tank 202 of this embodiment can be configured similarly to the tank 110 described above. The rupture disc valve assembly 200 prevents the flow of pressurized fluid 203 and gas 205 from the tank 202 until a desired time, at which point the pressurized fluid 203 and gas 205 is released along a linear flow path F through the valve assembly 200 and into the rest of the system.

The rupture disc valve assembly 200 includes a valve body 207 having an inlet conduit member 204 and a housing 206 longitudinally coupled together, such as by welding described in more detail below, with the linear flow path F running therethrough. The inlet conduit 204 and the housing 206 both have cylindrical configurations with generally annular sidewalls. The inlet conduit 204 includes an upstream portion 208 and a downstream portion 212. By one approach, the upstream and downstream portions 208, 212 can have a uniform interior diameter so that an interior 222 thereof has a smooth surface. Further, the upstream portion 208 can have an outer diameter that is smaller than an outer diameter of the downstream portion 212, such that the sidewall of the downstream portion 212 is thicker than the sidewall of the upstream portion 208.

The inlet conduit 204 is coupled to the tank 202 at the upstream portion 208 thereof by any suitable method, such as threading 210 as shown, welding, and so forth. The inlet conduit 204 is further coupled to the housing 206 at the thicker walled downstream portion 212 thereof, by any suitable method including a weld joint 213 as shown, threading, and so forth. As discussed above, the thicker wall of the downstream portion 212 can have an increased outer diameter with respect to the thinner-walled upstream portion 208 thereof so that the inlet conduit 204 includes a radially-extending shoulder surface 214 extending therebetween. So configured, the inlet conduit 204 can be welded to the housing 206 along an outer edge 216 of the shoulder surface 214, an outer edge 218 of a distal downstream end 220 of the inlet conduit 204, or both.

The upstream portion 208 of the inlet conduit 204 is open to the tank 202 such that the interior 222 of the inlet conduit 204 is pressurized to the same pressure as the tank 202. The downstream portion 212 of the inlet conduit 204 is closed by a rupture disc 224 extending across the distal downstream end 220 thereof, such that the rupture disc 224 blocks flow from the tank 202. By one approach, the rupture disc 224 is integral with the inlet conduit 204 so that they have a unitary, one-piece construction. By another approach, the rupture disc 224 can be welded to the distal downstream end 220 of the inlet conduit 20. The rupture disc 214 can further have a flat configuration as shown in FIG. 17 or can have domed configuration, as discussed above.

The rupture disc 224 includes a frangible central portion 226 that is configured to rupture at a predetermined burst pressure depending on several factors relating to its configuration, including the thickness of the central portion 226 and the amount, type and configuration of any scoring provided in either or both of upstream 228 or downstream 230 surfaces thereof. In the illustrated form, the central portion 226 includes generally centrally disposed X-shaped scoring 232 in the downstream surface 230 thereof. The rupture disc 224 can further include an outer ring portion 234 extending about the central, scored portion 226 thereof.

As shown, the housing 206 includes an upstream portion 236 and a downstream portion 238, each having a cylindrical configuration. By one approach, the upstream portion 236 can have a smaller interior diameter than the downstream portion 238 so that a radially-extending shoulder surface 240 extends therebetween within an interior 242 of the housing 206. The outer diameters of the upstream and downstream portions 236, 238 can preferably be the same so that the outer surface of the housing 206 is smooth across both portions 236, 238. As described above, the housing upstream portion 236 can be coupled to the inlet conduit downstream portion 212 and, more specifically, an interior edge 244 of the shoulder surface 238 can be welded to the outer edge 218 of the inlet conduit distal downstream end 220 at the weld joint 213 therebetween.

In order to control flow of the pressurized fluid 203 and gas 205 from the tank 202, the rupture disc 224 is configured to burst at a lower pressure than the pressure within the tank 202 and the rupture disc 224 is prevented from bursting until a desired time. To achieve this, the rupture disc 224 is controllably reinforced or braced on the downstream surface 230 thereof. By one approach, the housing 206 includes a pivotable support plate 246 that is configured to extend along and brace the downstream surface 230 of the rupture disc 224 so that the pressure within the tank 202 does not burst the disc 224.

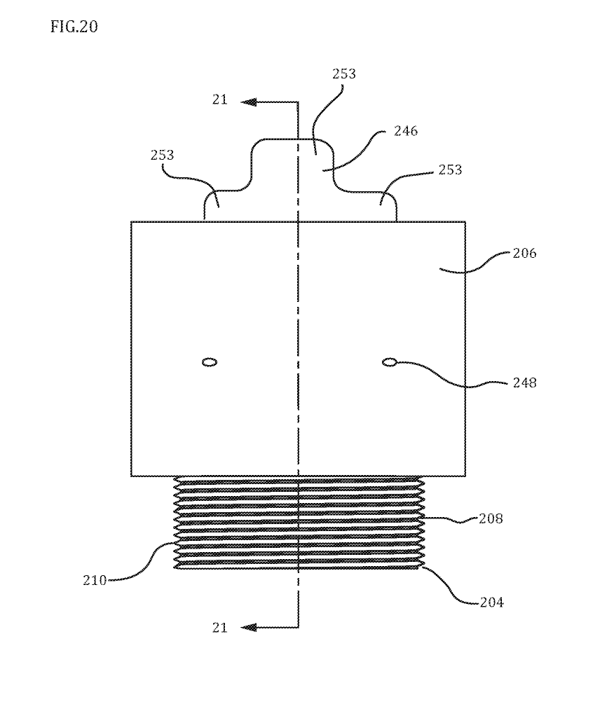

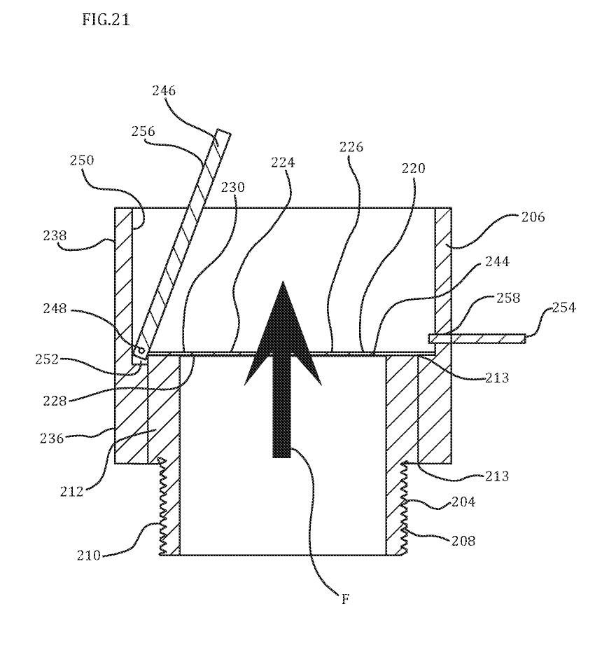

More specifically, the support plate 246 is pivotable about a hinge 248 mounted to the housing 206 from a first, support position, as shown in FIG. 19, extending along and abutting the rupture disc downstream surface 230 to a second, non-support position, as shown in FIGS. 20 and 21, extending downstream and pivoted away from the rupture disc 224. Advantageously, the hinge 248 is disposed adjacent to an interior surface 250 of the housing 206 so that when the support plate 246 pivots to the second position, the plate 246 is positioned generally along the interior surface 250 and along the flow path F, so that the plate 246 does not impede or restrict flow of the fluid 203 through the housing 206. If desired, the hinge 248 can be disposed within a recess 252 in the shoulder surface 240, such that the support plate 246 can extend parallel to the inlet conduit downstream end 220 in the first position, as shown in FIG. 19.

The support plate 246 can take any desired form that sufficiently braces the rupture disc 224 against bursting and against wear. By one approach, the support plate 246 can have a cross configuration so that the crossed portions 253 thereof extend over and along the x-shaped score 232 of the rupture disc 224, such as that shown in FIG. 17. By another approach, the support plate 246 can be annular and sized to generally match the diameter of the rupture disc central frangible portion 226 including the score 232 therein.

To hold the support plate 246 in the first position bracing the rupture disc 224, the housing 206 further includes a release 255 including a retractable pin or holder member 254 that extends transversely to the flow path F to be in interference with and preferably abut a downstream surface 256 of the support plate 246 such that the pin 254 restrains the support plate 246 from pivoting to the second position. As such, the pin 254 is preferably of a rigid material and construction having a sufficient strength to hold the support plate 246 against the rupture disc 224 and prevent the rupture disc 224 from bursting without deforming.

In the illustrated form, the pin 254 extends through a radial through opening or bore 258 in the thinner wall upstream portion 238 of the housing 206. The bore 258 is preferably sized to have a cross-section closely matching a cross-section of the pin 254 so that leaks of the fluid 203 or gas 205 therethrough are minimized. The release can further include an actuator 260 to control movement of the pin 254. More specifically, retraction of the pin 254 can be controlled by a solenoid as shown or other suitable actuator in communication with the system. For example, in a fire suppressant system, the solenoid 260 can be in communication with the fire alarm system and configured to receive a fire event signal therefrom. In response to receiving the fire event signal, the solenoid 260 can retract the pin 254 to a position clear of the support plate 246, such that the support plate 246 is no longer in interference with the rupture disc 224 bracing and supporting it against rupture. The pressure within the tank 202 can then burst the rupture disc 224 and flow of the fluid 203 and gas 205 along the flow path F pivots the support plate 246 to the second position.

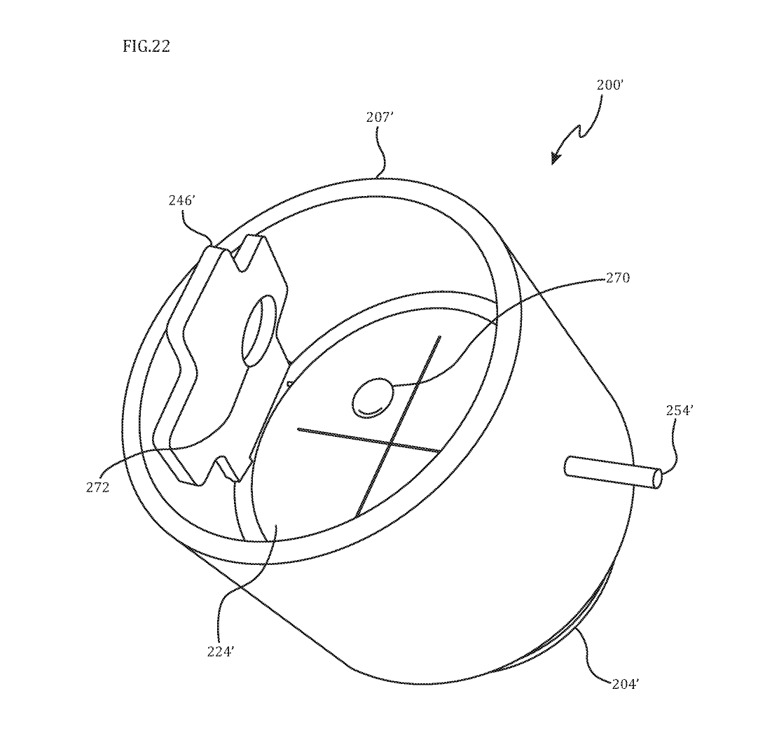

By a further approach, a rupture disc valve assembly 200′ shown in FIGS. 22-24 can be configured to atomize the liquid suppressant 203′ with the gas 205′ so that flow through the valve body 207′ and the rest of the fire suppressant system is as an atomized gas, rather than the relatively slower liquid suppressant 203′. The valve assembly 200′ of this form is largely similar to the previously described valve assembly 200 and, therefore, only the differences will be described herein.

As shown in FIGS. 24, the inlet conduit 204′ of this form includes a radially inwardly tapering portion 262 extending along the interior 222′ thereof. The tapering portion 262 tapers radially inwardly as it extends along the flow path F′ to thereby narrow the diameter of the inlet interior 222′. As shown, the tapering portion 262 can begin at an upstream end 264 of the inlet conduit 204′. Further, if desired, a downstream end portion 266 of the tapering portion 262 can be inclined to thereby taper to the relatively larger diameter of the downstream portion 212′. Alternatively, the downstream end portion 266 can extend radially.

Further, the inlet upstream portion 208′ can include an interior thread 274 along the interior 222′ thereof and an exterior thread 276 along an exterior cylindrical surface 278 thereof. So configured, the exterior thread 276 is configured to couple to a cooperating threaded coupling portion 280 of the tank 202′. The interior thread 274, meanwhile, is configured to couple to an elongate siphon member 282 having a threaded portion 284 at a first end 286 thereof. The siphon member 282 extends within the tank 202′ from the first end 286 to a second end 288 thereof that is spaced from an end wall 290 of the tank 202′, which as shown can be closely adjacent thereto.

So configured, in response to receiving the fire event signal, the solenoid 260′ can retract the pin 254′ to a position clear of the support plate 246′, such that the support plate 246′ is no longer bracing the rupture disc 224′. The pressure within the tank 202′ can then burst the rupture disc 224′ and the gas 205′ will push the fluid 203′ through the siphon member 282 along the flow path F′ through the valve body 207′, pivoting the support plate 246′ to the second, non-support position. As such, the tapering portion 262 gradually contracts the fluid flow radially along the flow path F′, which then radially expands at the downstream end portion 266 thereof.

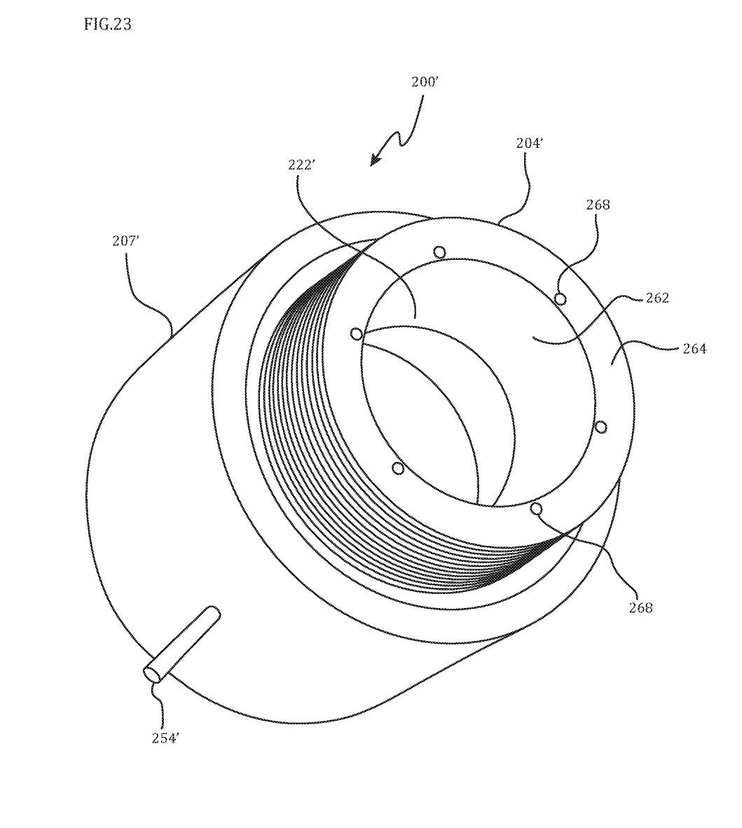

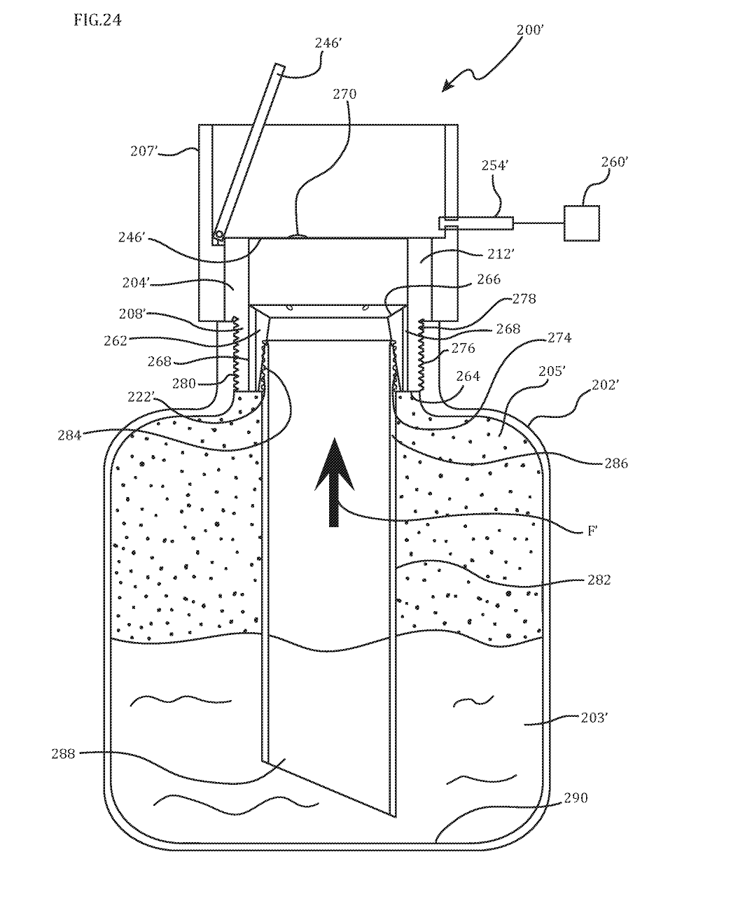

Advantageously, the tapering portion 262 can include atomizing throughbores 268 extend therethrough generally parallel with the flow path F′. The throughbores 268 extend from the upstream end 264 of the inlet conduit 204′ to the downstream end portion 266 of the tapering portion 262. So configured, when the pressure of the tank 202′ bursts the rupture disc 224′, the pressurized gas 205′, in addition to forcing the liquid suppressant 203′ through the siphon member 282, flows through the throughbores 268 and is injected into the liquid suppressant 203′ while the suppressant 203′ flows through the inlet conduit 204′ to effectively atomize the liquid suppressant 203′. In the form illustrated in FIG. 23, the inlet conduit 204′ includes 6 radially spaced throughbores 268. Of course, other amounts and spacing can also be utilized as desired.

In another form, the rupture disc ′224 can include a pressure relief portion 270 that is configured to burst when exposed to pressures at or above a predetermined pressure. The pressure relief portion 270 is configured to act as a separate rupture disc that acts independently of the rupture disc ′224 to thereby ensure that pressures within the system do not reach undesirably high levels, notwithstanding any support plates or back pressure, as described above. More specifically, the diameter, thickness, and scoring, if any, of the pressure relief portion 270 can be configured such that the pressure relief portion 270 will burst when exposed to a pressure at or above a desired pressure. Although the pressure relief portion 270 is described with reference to this embodiment, any of the rupture discs described herein can have a similar configuration. The pressure relief portion 270 acts as a secondary burst disc portion to replace the functionality of a separate pressure relief valve for the tank 202.

In a first form, the pressure relief portion 270 can be formed in the rupture disc 224′ utilizing the same material thereof. For example, the rupture disc 224′ can be formed to desired specifications, including any desired thickness, scoring, and doming. Thereafter, the rupture disc 224′ can be subsequently machined or pressed to form the pressure relief portion 270 thereof into a desired configuration. In the illustrated form, the pressure relief portion 270 has a domed configuration.

In a second form, the rupture disc 224′ can be formed to desired specifications and an opening can be cut therethrough where the pressure relief portion 270 is desired. Thereafter, the pressure relief portion 270, which in this form can be formed using any desired material, can be welded within the opening.

Further, in order to allow the pressure relief portion 270 to burst while the support plate 246′ is bracing the rupture disc 224′, as described above, the support plate 246′ can include a through opening 272 extending therethrough that is configured to align with, and provide clearance for, the pressure relief portion 270 while the support plate 246′ extends along the rupture disc 224′ in the support position thereof. Preferably, the through opening 272 is sized to have a diameter that provides clearance for a diameter of the pressure relief portion 270 so that portions of the rupture disc ′224 extending around the circumference of the pressure relief portion 270 is braced by the support plate 246′. So configured, if the pressure within the tank 202′ rises to undesirable levels, the pressure can burst the pressure relief portion 270 notwithstanding the support plate 246′ bracing the rupture disc 224′.

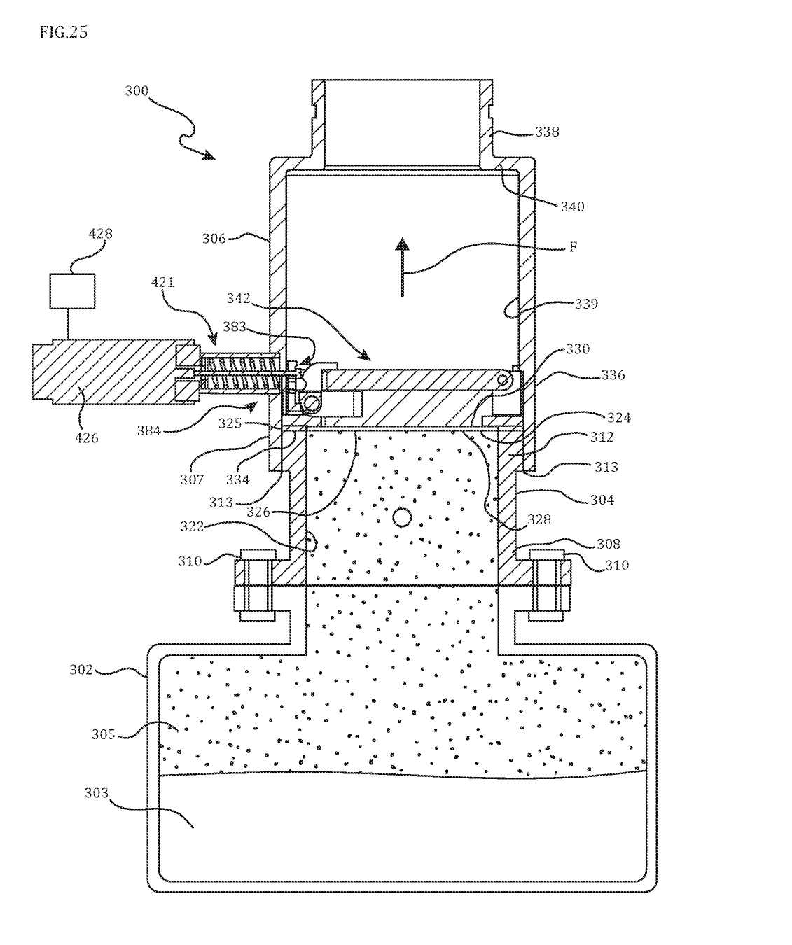

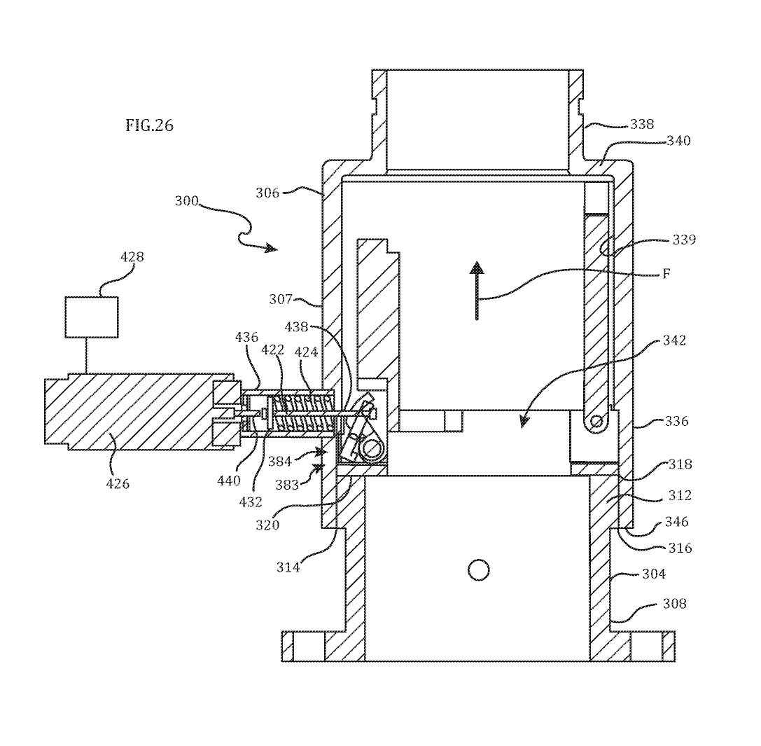

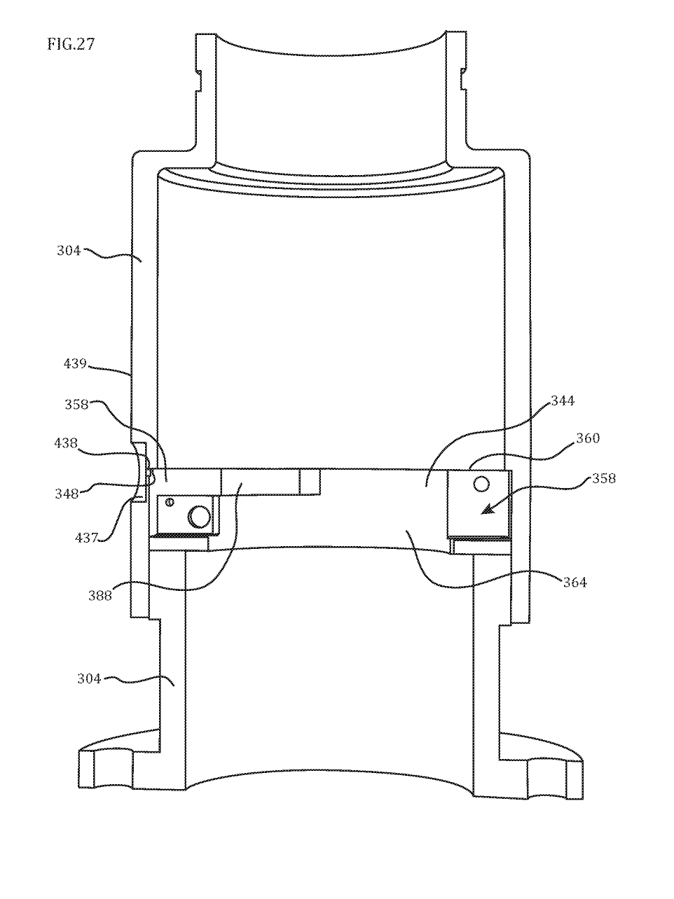

A rupture disc valve assembly 300 for a pressurized system, such as a fire suppressant system, is shown in FIGS. 25-32. The rupture disc valve assembly 300 of this form is mounted to a pressurized structure, which can be a separate component or system, such as a tank 302 as shown in FIG. 25. The tank 302 of this embodiment can be configured similarly to the tank 110 described above. The rupture disc valve assembly 300 prevents the flow of pressurized liquid 303 and gas 305 from the tank 302 until a desired time, at which point the pressurized liquid 303 and gas 305 is released along a flow path F through the valve assembly 300 and into the rest of the system. In the illustrated form, the valve assembly 300 has a linear flow path F allowing fast delivery of the liquid 303 and gas 305 therethrough.

The rupture disc valve assembly 300 of this form includes a valve body 307 having an inlet conduit member 304 and a housing 306 longitudinally coupled together, by any suitable method, such as by welding described in more detail below, with the flow path F running therethrough. The inlet conduit 304 and the housing 306 both have cylindrical configurations with generally annular sidewalls.

The inlet conduit 304 includes an upstream portion 308 and a downstream portion 312. The inlet conduit 304 is coupled to the tank 302 at the upstream portion 308 thereof by any suitable method, such as threading as shown in the above embodiments, welding, fasteners as shown in FIG. 25, and so forth. The downstream portion 312 of the inlet conduit 304 is further coupled to the housing 306 by any suitable method, including a weld joint 313 as shown, threading, fasteners, and so forth.

By one approach, the upstream and downstream portions 308, 312 can have a uniform interior diameter so that an interior 322 thereof has a smooth surface. Further, the upstream portion 308 can include an outer diameter that is smaller than an outer diameter of the downstream portion 312, such that the sidewall of the downstream portion 312 is thicker than the sidewall of the upstream portion 308. With this configuration, the inlet conduit 304 includes a radially-extending shoulder surface 314 extending therebetween. So configured, the weld joint 213 joining the inlet conduit 304 to the housing 306 can be disposed along an outer edge 316 of the shoulder surface 314, an outer edge 318 of a distal downstream end 320 of the inlet conduit 304, or both.

The upstream portion 308 of the inlet conduit 304 is open to the tank 302 such that the interior 322 thereof is pressurized to the same pressure as the tank 302. The downstream portion 312 of the inlet conduit 304 is closed by a rupture disc 324 extending across the distal downstream end 320 thereof, such that the rupture disc 324 blocks flow from the tank 302. By one approach, the rupture disc 324 is integral with the inlet conduit 304 so that they have a unitary, one-piece construction. By another approach, the rupture disc 324 can be welded to the distal downstream end 320 of the inlet conduit 304. For example, a periphery 325 of the rupture disc can be welded to the outer edge 318 of the inlet conduit distal downstream end 320.

Preferably, the rupture disc 324 has a flat configuration as shown in FIG. 25. By another approach, the rupture disc 324 can have domed configuration, as discussed above. The rupture disc 324 includes a frangible central portion 326 that is configured to rupture at a predetermined burst pressure depending on several factors relating to its configuration, including the thickness of the central portion 326 and the amount, type, and configuration of any scoring provided in either or both of upstream 328 or downstream 330 surfaces thereof. By one approach, the central portion 326 can include generally centrally disposed X-shaped scoring in the downstream surface 330 thereof, as shown in the above embodiment. The rupture disc 324 can further include an outer ring portion 334 extending about the central, scored portion 326 thereof.

As shown in FIG. 25, the housing 306 includes an upstream portion 336 and a downstream portion 338, each having a cylindrical configuration with annular sidewalls. The upstream portion 336 of the housing 306 has a larger interior diameter than the downstream portion 338 thereof such that the housing interior 339 includes a diameter reducing portion 340. By one approach, the diameter reducing portion 340 can be angled radially inwardly along the flow path F so that the portion 340 has a frusto-conical shape. By another approach, the diameter reducing portion 340 can extend in a generally transverse direction with respect to the flow path F.

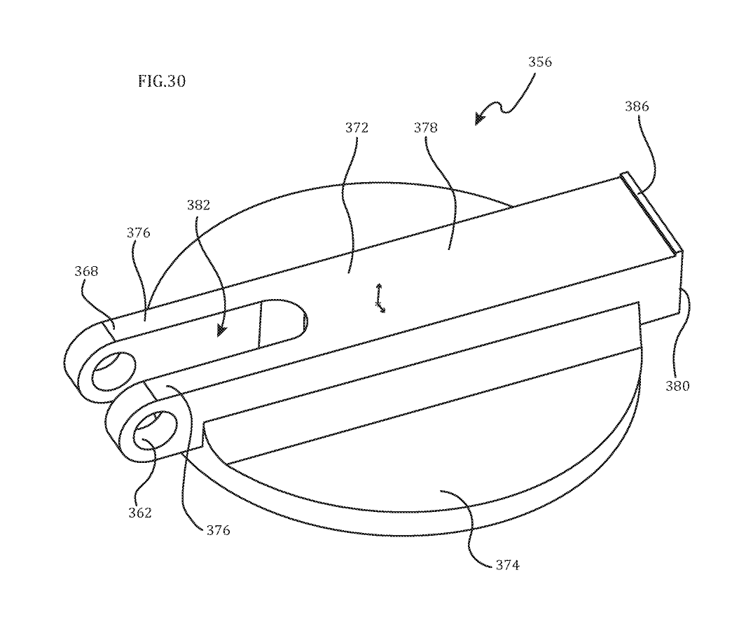

The valve assembly 300 further includes a support assembly 342, shown in FIG. 29. The support assembly 342 is disposed within the valve assembly 300 to brace the rupture disc 324 against bursting until a desired time. The support assembly 342 includes a ring portion or member 344 that is configured to be oriented within the housing 306 so that the flow path F passes therethrough. By one approach, the ring portion 344 can be a separate component secured within the housing 308 by any suitable method, such as welding, friction fit, or interaction with other components as described in more detail below. By another approach, the ring portion 344 can be integral with the housing 306 such that they have a unitary, one-piece construction.

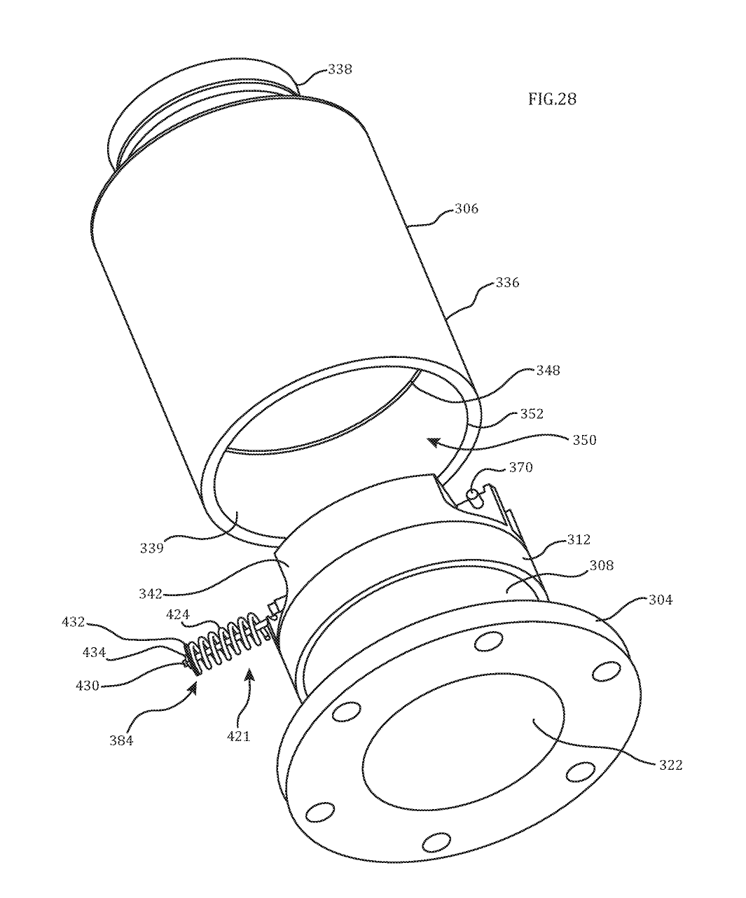

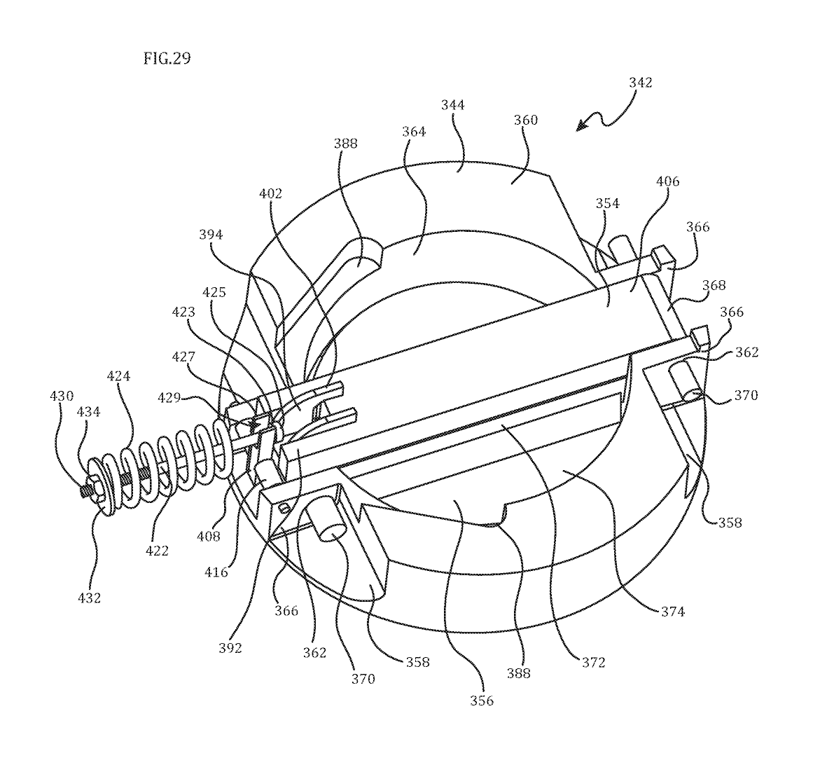

The ring portion 344 is disposed within the interior 339 of the housing 306 spaced from an upstream distal end 346 thereof. In one embodiment shown in FIG. 28, the housing 306 includes an inwardly extending lip or shoulder 348 configured to provide a stop surface for the ring portion 344 when the ring portion 344 is inserted into the housing 306 through the upstream end 336 thereof. In the illustrated form, the shoulder 348 is spaced from the upstream distal end 346 of the housing 306 a greater length than the longitudinal thickness of the ring portion 344 such that the housing 306 with the ring portion 344 received therein includes a upstream-facing pocket or recess 350 that is sized to receive the downstream portion 312 of the inlet conduit 304 therein. So configured, the weld joint 313 can be disposed between the outer edge 318 of the inlet conduit 304 and an interior corner 352 of the housing upstream distal end 346 securing the ring portion 344 in the housing 306.

In order to control flow of the pressurized liquid 303 and gas 305 from the tank 302, the rupture disc 324 is configured to burst at a lower pressure than the pressure within the tank 302 and the rupture disc 324 is prevented from bursting until a desired time. To achieve this, the rupture disc 324 is controllably reinforced or braced on the downstream surface 330 thereof.

In the illustrated form, the support assembly 342 includes two pivotable support members that are configured to collectively brace the downstream surface 330 of the rupture disc 324 so that the pressure within the tank 302 does not burst the disc 324 until a desired time. More specifically, the support members pivotably couple to the ring portion 344 at opposite sides of the housing 306 from one another and include a downstream, secondary member 354 and an upstream, primary member 356. The members 354, 356 are configured to pivot from a first position extending across the housing interior 339 generally transverse to the flow path F through the valve assembly 300 and a second position extending generally along the flow path F away from the inlet conduit 304.

In the first position, the support members 354, 356 are in a stacked configuration where the primary member 356 extends along and braces the downstream surface 330 of the rupture disc 324 and the secondary member 354 extends along and braces the primary member 356. So configured, the primary member 356 is sandwiched between the rupture disc 324 and the secondary member 354. Due to the support members 354, 356 being pivotably coupled to the ring portion 344 at opposite sides of the housing 306, in the second position, the support members 354, 356 extend along the flow path F adjacent to the interior surface 339 of the housing 306 at opposite sides thereof.

Details of an example ring portion 344 are shown in FIG. 29. The ring portion 344 has an exterior diameter sized to fit within the housing interior 339 and an interior diameter generally equal to or slightly smaller than the interior diameter of the inlet conduit 304. The ring portion 344 includes opposing outer recesses 358 on a downstream end 360 thereof sized to receive pivotable couplings 362 of the support members 354, 356. More specifically, the recesses 358 can be section-shaped on opposite sides of the ring portion 344 where the chord side of the section is spaced radially outward from an interior 364 of the ring portion 344. To provide the pivotable couplings 362 with the support members 354, 356, the ring portion 344 can include upstanding wall portions 366 within the recesses 358 that are spaced from one another to receive ends 368 of the support members 354, 356 therebetween. With this configuration, a pivot member 370 can extend through the upstanding wall portions 366 and the ends 368 of the support members 354, 356 to provide the hinge connection 362 therebetween. In the illustrated form, the hinge member 370 for the primary support member 356 is larger than the hinge member 370 for the secondary support member 354. Of course, any suitable size can be utilized.

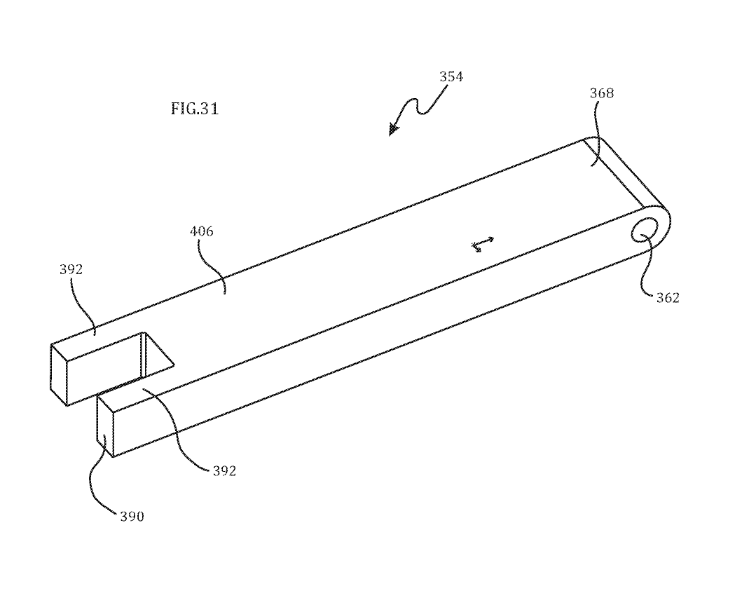

An example primary support member 356 is shown in FIG. 30. The primary support member 356 includes an elongate backing portion 372 and a plug portion 374. The elongate backing portion 372 includes opposing leg portions 376 on the pivot end 368 thereof and a main portion 378 extending from the leg portions 376 to a distal end 380 of the primary member 356. The leg portions 376 have a recess 382 therebetween sized so that one or more components of a release 383, as described in more detail below, can extend therebetween to secure the secondary member 354 in the first position.

In the illustrated form, the backing portion 372 has a length such that it extends entirely across the interior diameter of the ring portion 344 to project at least partially into the recess 358 of the ring portion 344 for the pivot connection 362 of the secondary member 354. In the illustrated form, the backing portion 372 is generally box-shaped. As shown in FIG. 30, the backing portion 372 can include a projecting lip 386 configured to engage the secondary member 354. In the illustrated form, the lip 386 is disposed on the distal end 380 of the primary member 356. Of course, the lip 386 can be spaced from the distal end 380 by any suitable distance to configure the forces within the support assembly 342 as desired. The lip 386 advantageously abuts the secondary member 354 while the support members 354, 356 are in the first position and acts as a line for directing forces acting on the primary member 356 to the secondary member 354. Although a lip 386 in the form of a line is shown, the lip 386 can take any suitable shape, such as a point, multiple lines, or combinations thereof. Because the lip 386 is disposed adjacent to the pivot connection 362 for the secondary member 354, the forces acting on the release 383 and other components of an actuator 421 described below are lower than those compared to the pin and single support plate embodiment described above. More specifically, forces acting on the primary member 356 from the rupture disc 324 are imparted on the secondary member 354 through the lip 386 and as a result of the lip 386 engaging the secondary member 354 closely adjacent to the pivot connection 362 thereof, a majority of the forces are directed into the pivot connection 362, ring portion 344, and housing 306, rather than a majority being directed into the release 383.

In one example, the configuration of the primary member 356, and the lip 386 thereof, along with the secondary member 354, reduces the force acting on the portion of the release 383 retaining the secondary member 354 in the first position thereof as compared to forces acting on the primary member 356 from the rupture disc 324 by at least 80 percent. For example, in a setup where forces acting on the primary support member 356 from the rupture plate 324 are in excess of 1000 pounds, the support assembly 342 configuration shown in the figures reduces the force acting on the release 383 from the secondary member 354 to around 200 pounds or less. Desired force distribution outcomes can be achieved by varying the length of the support members 354, 356, and varying the location of the lip 386.

The plug portion 374 of the primary member 356 is disc shaped and is sized to fit within the interior 364 of the ring portion 344 such that the ring portion 344 extends thereabout. Preferably, the plug portion 374 is configured to have a maximum diameter sized so that the plug portion 374 is capable to pivot into and out of the ring portion interior 364 without interference. Further, the plug portion 374 has a longitudinal thickness such that it extends to rest against the rupture disc 324 to brace the disc 324 against rupture when the primary member 356 is in the first position. So configured, the plug portion 374 is sized to abut and brace a majority of the rupture disc 324 and, preferably, substantially all of the frangible central portion 326 of the rupture disc 324.

As shown in FIG. 30, the ring portion 344 can also include recesses 388 configured to reduce the longitudinal thickness of the ring portion 344 along the interior 364 thereof in areas in a pivot range of the primary support member 356 when it pivots between the first and second positions. With the recesses 388, the ring portion 344 can have a greater thickness in adjacent areas while also providing a clear pivoting path for the plug portion 374 configured as described above to abut and brace a majority of the rupture disc 324.

An example secondary support member 354 is shown in FIG. 31. Due to the primary member plug portion 374 providing support for the rupture disc 324, the secondary member 354 need only extend along and brace the primary member 356. Due to the opposing pivot connections 362, the secondary member 354 also provides an offset pivot 362 with regard to the support assembly 342, which distributes the forces acting on the support assembly 342.

In the illustrated form, the secondary member 354 has an elongate shape with a length sized to extend across the ring portion 344 interior diameter such that a distal end 390 thereof is disposed adjacent to the housing interior surface 339 downstream of the pivot connection 362 of the primary member 356. The secondary member 354 can be generally box-shaped as shown, or can take any other suitable shape. If desired, the secondary member 354 can include spaced leg portions 392, similar to the primary member 356, on the distal end 390 thereof so that the leg portions 392 extend on either side of components of the release 383.

An example actuator 421 is shown in FIGS. 25, 26, and 32. The actuator 421 is configured to hold the secondary member 354 in the first position until a desired time. On command, the actuator 421 is configured to release interference with the secondary member 354, which allows the secondary member 354 to pivot as a result of forces applied thereto by the primary member 356. As the secondary member 354 pivots, the primary member 356 also pivots due to forces pressing against the rupture disc 324. When the bracing from the primary member 356 fails to sufficiently compensate the rupture disc 324 against the pressure within the tank 302, the rupture disc 324 bursts, which allows the liquid 303 and gas 305 within the tank 302 to flow through the valve assembly 300. The liquid 303 and gas 305 flow past the support members 354, 356 causing them to pivot to the second position, which decreases disturbance to the flow through the valve assembly 300.

To interact with the secondary member 354, the release 383 of the actuator 421 includes a latching mechanism 384 that includes a stop or coupling member 394 with a projecting portion 396 that projects over and downstream of the secondary member 354 to restrict the secondary member 354 from pivoting from the first position thereof. In the illustrated form, the stop member 394 includes a base portion 398 having a through bore 400 extending laterally therethrough sized to receive the hinge member 370 of the primary support 356 therethrough such that the stop member 394 can pivot about the hinge member 370. The projecting portion 396 of the illustrated form includes a pair of prongs 402 that extend downstream of the base portion 398 and radially inwardly so that distal ends 404 thereof project over a downstream surface 406 of the secondary member 354.

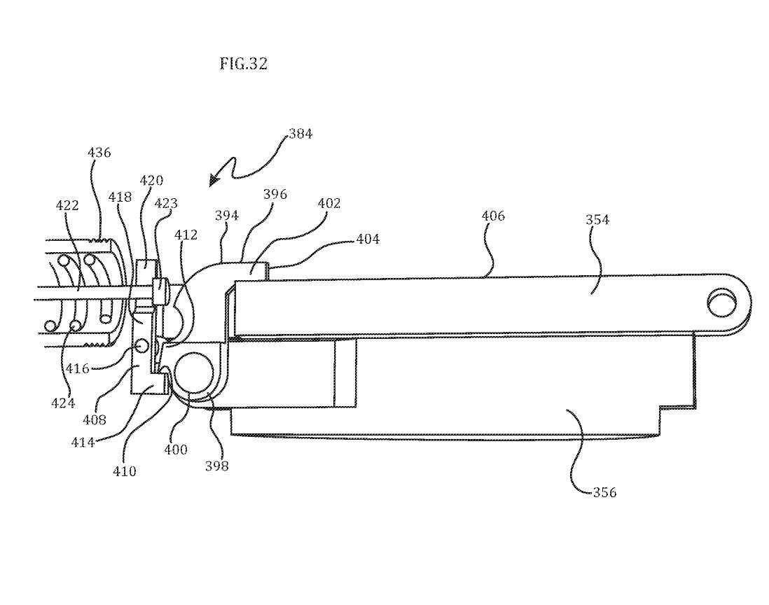

The stop member 394 is restricted from pivoting by a catch member 408 of the latching mechanism 384. The catch member 408 is pivotable between a first position restricting movement of the catch member and a second position that allows the stop member 394 to freely pivot such that the projecting portion 396 is driven radially outwardly by the secondary member 354. As shown in FIG. 32, the stop member 394 includes a stop surface 410 that projects radially outwardly along an outer portion 412 thereof. The catch member 408 includes a radially inwardly projecting portion 414 that, in the first position and until release is desired, projects upstream of the stop surface 410 to thereby restrict the stop member 394 from pivoting. The catch member 408 is further configured to about a pivot member 416 extending through an intermediate portion 418 thereof and a downstream portion 420 opposite of the projecting portion 396. To move to the second position thereof, the catch member 408 pivots about the pivot connection 416 thereof such that the projecting portion 414 pivots radially outwardly and the downstream portion 420 thereof pivots radially inwardly.

The actuator 421 is configured to control movement of the catch member 408. More specifically, as shown in FIG. 29, the actuator 421 includes a pin or shaft member 422 having an enlarged retaining portion 423 at one end 425 thereof adjacent to the catch member 408. In the illustrated form, the downstream portion 420 of the catch member 408 can include legs 427 having a recess 429 therebetween. The pin 422 is configured to project through the recess 429 such that the retaining portion 423 thereof is disposed radially inwardly of the downstream portion 420. The retaining portion 423 engages the downstream portion 420 to restrict movement thereof.

To retain the catch member 408 in the first position thereof by restricting movement of the pin 422, the actuator 421 further includes a biasing mechanism 424, such as a spring as shown, configured to impart a biasing force on the pin 422 to restrict movement of the pin 422 to thereby restrict movement of the catch member 408 and stop member 394.

As shown in FIG. 29, the other end 430 of the pin 422 includes a stop member 432. The stop member or portion 432 can be mounted to the pin 422, such as a washer as shown utilizing a nut 434, by welding, or other suitable method, or can be integral therewith. The pin 422 and spring 424 are disposed within an actuator housing 436 that is mounted to the housing 306, such as by mounting within a recess 437 in an outer surface 439 thereof by threading, welding, and so forth. The pin 422 extends within the actuator housing 436 and projects into the housing 306 through an opening or bore 438 therein so that the end 425 thereof is disposed adjacent to the catch member 408 as described above. Preferably, the stop portion 432 is sized to engage the spring 424 so that the spring 424 is captured between the stop portion 432 and the housing 306. Of course the actuator housing 436 can include an end wall portion to engage the spring 424.

So configured, the forces acting on the stop member 394 of the release 383 cause the catch member 408 to be forced toward the second position thereof. This causes the downstream portion 420 thereof to impart a force on the retaining portion of the pin 422 to shift radially inwardly. The spring 424 engages the stop portion 432 and the housing 306 and compresses due to the forces applied to the pin 422. Preferably, the spring 424 is configured with a spring constant and sized, along with the spacing between the stop portion 432 and the housing 306, to apply a biasing force to the pin in a first compressed state thereof that restricts movement of the pin 422 thereby restricting movement of the catch member 408 and the stop member 394. As such, the spring 424 bias is configured to offset the forces created by bracing the rupture disc 324 and retain the primary and secondary members 356, 354 in the first positions thereof maintaining an equilibrium for the valve device 300. By one approach, setting of the first compressed state of the spring 424 can conveniently be achieved by movement of the stop portion 432 laterally along the pin, such as by using the nut 434 as shown.

Due to the configuration of the actuator 421, and the release 383 thereof, the spring constant of the spring 424 can be relatively small as compared to the forces acting on the stop member 394, let alone the primary member 356. For example, the spring constant can be configured to offset about 20 percent of the force acting on the stop member 394, or 4 percent or less of the force acting on the primary member 356 from the rupture disc 324.

In the above example where the forces acting on the primary support member 356 from the rupture plate 324 are in excess of 1000 pounds, the spring 424 can be configured to offset about 40 pounds to prevent the pin 422 from shifting to thereby release the stop member 394. Desired force distribution outcomes can be achieved by varying the length and size of the components of the latching mechanism 384.

Subsequent movement of the pin 422 is controlled by a powered actuator 426, such as a solenoid or similar device. The solenoid 426 is in communication with a control circuit 428 of the system and configured to receive a signal therefrom. As set forth above, the spring 424 is configured to retain the support members 354, 356 in the first positions thereof without power being supplied to the powered actuator 426. When release of the gas 303 and liquid 305 is desired, such as in response to a fire alarm signal, the control circuit 428 sends a signal to the solenoid 426. Upon reception of the signal, the solenoid 426 is configured to expel a plunger 440 within the actuator housing 436 to, engage the end 430 of the pin 422 if spaced therefrom, and shift the pin 422 radially inwardly. The plunger 440 shifting the pin 422 causes the spring 424 to compress further to a second compressed state and shifts the retaining portion 423 of the pin 422 within the housing 306. Because the retaining portion 423 no longer restricts movement of the catch member 408, the catch member downstream portion 420 is allowed to pivot inwardly, causing the inward projecting portion 414 to pivot outwardly and disengage from the stop surface 410 of the stop member 394. Without the catch member 408 engaging the stop surface 410, the stop member 394 is unable to hold the secondary member 354 in the first position. The pressure within the tank 302 presses against the rupture disc 324 until the primary member 356 is pivoted away from the rupture disc 324 sufficiently to allow the rupture disc 324 to burst due to the pressure within the tank 302. Thereafter, the liquid 303 and gas 305 flows into and past the support members 354, 356 pushing the support members 354, 356 to the second position. By another approach, the pin 422 can be pivotably mounted to the catch member 408 to control movement thereof.

Advantageously, utilizing the spring 424 allows the solenoid 426 to impart a relatively low force in order to shift the pin 422 and cause the liquid 303 and gas 305 to be released. For example, the solenoid 426 can be configured to assert about 5-10 percent of the force as compared to the forces acting on the stop member 394 or about 30 percent of the force applied by the spring 424 to maintain the device 300 in equilibrium. In the above example where forces acting on the primary support member 356 from the rupture plate 324 are in excess of 1000 pounds, the solenoid 426 can be configured to apply about 12 pounds of force to the pin 422 to thereby compress the spring 424 and pivot the catch member 408 out of engagement with the stop member 394.

As such, the valve device 300 described herein can advantageously be configured for specific systems, having varying pressure and size requirements, to produce a desired force distribution to achieve a desired force requirement for the spring 424 and solenoid 426.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 428 may be configured (for example, by using corresponding programming stored in a memory as will be well understood by those skilled in the art) to carry out one or more of the steps, actions, and/or functions described herein.

Those skilled in the art and will recognize that a wide variety of modifications, alterations, and combinations can be made with respect to the above described embodiments without departing from the spirit and scope of the invention, and that such modifications, alterations, and combinations, are to be viewed as being within the scope of the invention.

1. A valve device for selective release of a pressurized material, the valve device comprising:
a valve body having an inlet, an outlet, and a throughbore having opposite ends at which the inlet and outlet are disposed;
an inlet conduit member of the valve body having the inlet of the valve body at an upstream end thereof and an opposite downstream end;
a rupture disc of the inlet conduit member extending across the downstream end thereof to block flow therethrough, the rupture disc having a frangible central portion configured to rupture at a predetermined pressure, the predetermined pressure being less than a pressure of the pressurized material;
a housing of the valve body having an interior sized to receive the inlet conduit member downstream end therein such that the rupture disc is disposed within the housing;
a support member pivotably mounted to the valve body adjacent to the rupture disc with the inlet conduit member received in the housing, the support member being configured to pivot between a first position extending along and bracing the rupture disc keeping the rupture disc from bursting due to the pressurized material and a second position pivoted away from the rupture disc; and
a release having a stop member movable between a retaining position in interference with the support member for keeping the support member from pivoting away from the first position and a release position in clearance with the support member for allowing the support member to pivot to the second position.

2. The valve device of claim 1, wherein, in the first position, the support member is configured to brace a majority of the frangible central portion of the rupture disc.

3. The valve device of claim 1, wherein the rupture disc is integral with the inlet conduit member.

4. The valve device of claim 1, further comprising a siphon coupled within the inlet conduit member upstream end; and wherein the pressurized material includes pressurized liquid and gas, and the inlet conduit member upstream end is configured to be inserted into a container having the pressurized fluid and gas therein such that a distal end of the siphon is inserted into the pressurized liquid; and
wherein the inlet conduit member upstream end includes a sidewall extending therearound with one or more throughbores extending generally along the flow path within the sidewall, the throughbores having one end open to the container and a second end open to an interior of the inlet conduit member such that when the rupture disc bursts, at least initially, the pressurized liquid exits the container through the siphon and the pressurized gas exits the container through the one or more throughbores.

5. The valve device of claim 1, wherein the support member comprises a primary support member, and further comprising a secondary support member downstream from the upstream, primary support member; and
wherein the primary and secondary support members are pivotably coupled to the valve body at opposite sides thereof, the secondary support member is configured to pivot between a first position extending along and bracing the primary support member and a second position pivoted away from the primary support member, and in the retaining position, the stop member of the release is in interference with the secondary support member and, in the release position, the stop member is spaced from the secondary support member.

6. The valve device of claim 5, wherein the primary support member includes a projecting lip configured to engage the secondary support member adjacent to a pivot connection between the secondary support member and the valve body with the primary and secondary support members in the first position and transfer forces imparted on the primary support member by the rupture disc to the secondary support member therethrough.

7. The valve device of claim 5, wherein the valve body further includes a ring member sized to fit in the housing, and the primary and secondary support members are pivotably coupled to the ring member, the primary support member including a plug portion configured to have the ring member extend thereabout in the first position thereof.

8. The valve device of claim 5, further comprising an actuator for operating the release, wherein the release comprises a pivoting catch member configured to selectively restrict movement of the stop member, and a pin of the actuator is operable to be shifted from a first position restricting movement of the catch member to a second position to allow the catch member to pivot for allowing movement of the stop member from the retaining position to the release position.

9. The valve device of claim 8, wherein the actuator further includes a biasing mechanism configured to apply a biasing force to the pin to retain the pin in the first position thereof.

10. A valve device for selective release of a pressurized material, the valve device comprising:
a valve body having an inlet, an outlet, and a throughbore extending therethrough having opposite ends at which the inlet and outlet are disposed;
a rupture disc of the valve body extending across the throughbore to block flow therethrough, the rupture disc having a frangible central portion configured to rupture at a predetermined pressure, the predetermined pressure being less than a pressure of the pressurized material;
a primary support member pivotably mounted to the valve body and configured to pivot between a first position extending along and bracing the rupture disc against rupture and a second position pivoted away from the rupture disc for allowing the rupture disc to rupture;
a secondary support member pivotably mounted to the valve body and configured to pivot between a first position extending along and bracing the primary support member against pivoting and a second position pivoted away from the primary support member for allowing the primary support member to pivot; and
a release configured to control pivoting of the primary and secondary support members and rupture of the rupture disc.

11. The valve device of claim 10, wherein the release includes a stop member movable between a retaining position in interference with the secondary support member for keeping the secondary support member from pivoting away from the first position and a release position in clearance with the secondary support member for allowing the secondary support member to pivot to the second position thereof which allows the primary support member to pivot to the second position thereof allowing the rupture disc to burst.

12. The valve device of claim 11, further comprising an actuator for operating the release, wherein the release comprises a pivoting catch member configured to selectively restrict movement of the stop member, and a pin of the actuator is operable to be shifted from a first position restricting movement of the catch member to a second position to allow the catch member to pivot for allowing movement of the stop member from the retaining position to the release position.

13. The valve device of claim 12, wherein the actuator further comprises a biasing mechanism configured to apply a biasing force to the pin to retain the pin in the first position thereof.

14. The valve device of claim 10, wherein the primary and secondary support members are pivotably mounted at opposite sides of the valve body.

15. The valve device of claim 10, wherein the primary support member includes a projecting lip configured to engage the secondary support member adjacent to a pivot connection of the secondary support member to the valve body with the primary and secondary support members in the first position and transfer forces imparted on the primary support member by the rupture disc to the secondary support member therethrough.

16. The valve device of claim 10, wherein the valve body comprises:
an inlet conduit member having an upstream end and an opposite, downstream end, the rupture disc extending across the downstream end to block flow therethrough;
a housing having an interior sized to receive the inlet conduit member downstream end therein such that the rupture disc is disposed within the housing.

17. The valve device of claim 10, wherein the valve body further comprises a ring portion mounted within the housing downstream of the inlet conduit member, the primary and secondary support members being pivotably mounted to the ring portion; and
wherein the primary support member includes a plug portion configured to have the ring portion extend thereabout in the first position, the ring portion and inlet conduit member being configured such that a bottom surface of the plug portion extends along and braces a majority of a frangible portion of the rupture disc in the first position.

18. A valve device for selective release of a pressurized material being stored within a container at a storage pressure, the valve device comprising:
a valve body having an inlet coupled to the container, an outlet, and a throughbore extending therethrough having opposite ends at which the inlet and outlet are disposed;
an upstream rupture disc oriented within the valve body to block flow therethrough and configured to burst at a first predetermined pressure that is less than the storage pressure;
a downstream rupture disc oriented within the valve body to block flow therethrough and configured to burst at a second predetermined pressure that is less than the storage pressure;
a chamber formed by the valve body, the upstream rupture disc, and the downstream rupture disc, the chamber having a pressurized fluid therein at a third predetermined pressure;
wherein the pressurized fluid within the chamber braces the upstream rupture disc such that the first predetermined pressure and back pressure support from the third predetermined pressure is greater than the storage pressure; and for release of the pressurized material, the chamber is configured to vent the pressurized fluid causing the pressurized material to sequentially burst the upstream and downstream rupture discs.

19. The valve device of claim 18, wherein the first predetermined pressure is greater than the second predetermined pressure.

20. The valve device of claim 18, wherein the upstream and downstream rupture discs each include a flat, outer ring portion and a frangible central portion; and the upstream and downstream rupture discs are mounted to the valve body to align the frangible central portions thereof with the throughbore of the valve body.

21. The valve device of claim 20, wherein the valve body includes:
a seat member having upstream and downstream ends and recessed seat portions having annular wall portions extending therearound in the upstream and downstream ends thereof, the upstream and downstream rupture discs being secured within the recessed seat portions of the upstream and downstream ends of the seat member, respectively; and
upstream and downstream retaining ring members configured to be received in the recessed seat portions of the seat member with the annular wall portions extending thereabout to capture the flat, outer ring portions of the upstream and downstream rupture discs between the respective retaining ring member and the seat member.

22. The valve device of claim 20, wherein the frangible central portions of the upstream and downstream rupture discs comprise frangible dome wall portions, and the frangible dome wall portions are oriented toward the inlet.

23. The valve device of claim 18, further comprising a siphon coupled within the inlet of the valve body, and wherein the pressurized material includes pressurized liquid and gas; the inlet of the valve body being configured to be inserted into the container such that a distal end of the siphon is inserted into the pressurized liquid; and
wherein the inlet of the valve body includes a sidewall extending therearound with one or more throughbores extending generally along the flow path within the sidewall, the one or more throughbores having one end open to the container and a second end open to an interior of the valve body, such that, when the upstream rupture disc bursts, at least initially, the pressurized liquid exits the container through the siphon while the pressurized gas exits the container through the one or more throughbores.
